(19) United States
(12) Patent Application Publication
(10) Pub. No.: US 2024/0369262 A1
(43) Pub. Date: Nov. 7, 2024

(54) ENCASEMENT SYSTEM FOR INTEGRATION OF SOLAR DEVICES INTO A STRUCTURE AND SOLAR DEVICES FOR USE IN THE SAME

(71) Applicant: Peter Elrick CUMMINGS, Fairfield, CT (US)

(72) Inventor: Peter Elrick CUMMINGS, Fairfield, CT (US)

(21) Appl. No.: 18/653,199

(22) Filed: May 2, 2024

Related U.S. Application Data
(60) Provisional application No. 63/499,561, filed on May 2, 2023.

(51) Int. Cl. F24S 25/20; F24S 10/40; F24S 80/40; H02S 20/22

(52) U.S. Cl. CPC F24S 25/20; F24S 10/45; F24S 80/40; H02S 20/22

(57) ABSTRACT

An encasement system or bay for the delivery of solar powered devices that is installed and structurally integrated into a building is provided. The encasement system or bay houses solar powered devices, such as solar heaters, solar coolers and photovoltaic devices, into a roof and/or wall of a building. As the solar devices are housed in the encasement system or bay, and the bay is embedded in the roof or wall of the building, the components of the solar devices are not exposed to the elements, and thereby have an increased output efficiency. Should the solar devices need repair or replacement, the encasement systems can be easily accessed, and the solar devices repaired or replaced, without a need for replacing the encasement system.

### CROSS-REFERENCE TO RELATED APPLICATIONS

This application claims the benefit under 35 U.S.C. § 119 (e) of U.S. Provisional Application No. 63/499,561 filed May 2, 2023, the contents of which are incorporated by reference herein in their entirety.

### BACKGROUND

### 1. Field of the Disclosure

The present disclosure is related to an encasement system or bay for the delivery of solar powered devices that is installed and integrated into a structure such as a building. More particularly, the present disclosure is related to an encasement system or bay for the delivery of solar powered devices, such as solar heating, solar cooling and photovoltaic devices, into a roof and/or side of a building, and the solar devices for use in the bay.

### 2. Description of Related Art

Current delivery systems for solar devices, such as photovoltaic panels, do not provide encasement systems or bays for housing the components of these solar devices that are mounted on a building. Current systems are installed above the roofs and into the shingles on a roof such as shingles 3060 shown in FIG. 1. This means that these solar devices are installed on the outer most layer of a roof or wall siding, which is above the plywood sheathing 3040 and 3100, and the ice/water shield barrier 3050 or 3120, used in typical building construction as shown in FIG. 1.

Therefore, these known systems are only integrated cosmetically into a building, or installed above the roof and not integrated structurally, meaning that they are not part of or integrated into the building components that provide structural integrity to the building's roof or siding.

Rafters are load bearing members comprising the main structural support for a roof. Rafters provide support for the roof sheathing and shingles while providing rigidity and stability to the roof structure. Rafters resist environmentally imposed loads, such as snow and wind, while resisting movements due to moisture or thermal variations.

Rafters such as rafters 3010 shown in FIG. 1, must be durable to give satisfactory performance and reduce maintenance to a minimum. Rafters typically run from the ridge board or ridge beam or hip of the roof at a sloping angle to the roof wall plate, or roof beams, depending on the support system adopted for the entire roof structure.

A load bearing wall supports the weight of the structural elements it connects to in a building such as roof and floors. Load bearing walls are vertical structural members supporting its own weight, the dead load of floors, ceilings, roof, snow, wind, weight of equipment, occupants, and furnishings on each floor. Load bearing walls distribute the building's weight from the roof through each floor and eventually down to the foundation. Load bearing walls provide complete support for the building/structure.

Roof and wall sheathing, such as structural roof sheathing 3040 and structural wall sheathing 3100 shown in FIG. 1, are the coverings placed as a strong layer of wood boards or wood structural panels, over roof rafters 3010 or roof trusses and wall studs 3011 providing the base for the application of roof shingles 3060 or wall cladding or siding 3130. The two most common types of roof and wall sheathing are made of either oriented strand board (OSB) or plywood. Shingles 3060 (the visible and outer part of a roof) are fastened to the sheathing, same as wall siding 3130.

The roof and wall sheathing provide integrity to the structure and the building at large by providing a solid surface between the rafters 3010 and studs 3011 with strength and stability to resist vertical and horizontal loads on the surface such as snow, ice (roof), wind, wind uplift (both roof and walls), while providing a barrier to water and moisture from seeping through the roof and wall structure. In addition, the sheathing is an essential component in resisting lateral (horizontal) forces caused by wind or seismic, being the essential element in the Main Lateral Resistive System, acting as diaphragm in the horizontal plane at the roof and floor levels, and shear wall in the vertical plain for walls.

Known delivery systems for solar devices do not replace and/or are not attached to structural components of the roof or siding of a house, such as the plywood sheathing, wall studs, or rafters, and are only attached to a buildings outer most layer of siding or roof shingles. These current systems have multiple drawbacks some of which are explained below.

First, known systems do not provide structural stability to the roof or siding of a building and may not be able to adequately resist lateral forces such as wind, wind uplift, snow loads and snow drifting without additional reinforcement which can add to costs. Second, known systems for solar devices do not have encasement systems or bays that are installed so that the bay is located in or embedded into the building's roof or walls, and thus expose the critical components of these solar devices to weather such as damaging UV radiation, cold, wind, snow, ice, heat or external temperatures, which reduces the efficiency of these solar devices. Further, these known systems do not provide adequate venting or cooling for the solar devices such as photovoltaic panels, which decreases their electrical efficiency.

Another drawback of known systems is that they add to the overall weight of the roof when installed, thereby potentially requiring structural reinforcement or additional support or renovation of existing roofs before they can be installed to meet existing building codes.

When a building is being newly constructed known systems do not provide a cost savings to building materials, as they are mounted on top of the most external layer such as the shingles or siding, and do not replace these and other construction materials such as the sheathing and barrier layer.

Accordingly, there is a need to overcome, alleviate, and/or mitigate one or more of the aforementioned and other deleterious effects of known systems for solar devices.

### SUMMARY

It is an object of the present disclosure to provide an encasement system or bay assembly that is embedded in a building's roof and/or walls, and thus replaces certain building materials where it is installed and is structurally integrated into the building so that it is connected to building components such as the building's rafters and wall studs that provide the building its structural integrity.

The bay as disclosed herein provides a bottom portion or tray that houses the solar device used with the bay, and a top portion, that can be a glass panel that is held in a frame, that is attachable to the tray and covers the solar device, so that the solar device is housed in the tray and beneath the glass panel.

The tray can have cutouts for the wiring, and/or plumbing for the solar device. In some embodiments, the tray has cutouts for airflow at a bottom and top location of the tray. In some embodiments, the top portion, or glass panel and frame, is slidably connected to the tray by sliding over a tray lip running the entire perimeter length of the tray.

The bay is attachable or connectable to a building's rafters and/or wall studs, preferably by hold down bars that are complementarily shaped to fit on and between the frames of adjacent and separate bays that are installed next to each other, or shaped to fit on a left end side, or right end side of a leftmost or right most bay (or single bay) and holds down the bay with bolts and/or screws running through holes in the hold down bar and into the rafter or wall studs.

A variety of solar devices can be housed in and used in conjunction with the bay, such as a solar heater, solar cooling plate and photovoltaic panels with thermal backing plate.

In some embodiments, a solar heater is used with the bay, so that at least one evacuated tube that is capable of absorbing heat, being connected to a heat exchanging device such as a water manifold, which is in turn connected to a cool water feed line, and a hot water return line. In some embodiments, the evacuated tube has a heat conductive material such a metal rod running through and within the length of the tube. The solar heating device when housed in the bay and installed in a roof or wall of a building, is capable of absorbing heat, such as solar energy, and exchanges or transfers the heat to the water running through the water manifold. The heated water is then routed throughout the house as needed, for various purposes, such as heating, domestic hot water for the building and heating pool.

In some embodiments, coolers and photovoltaic systems can be installed in the bay assemblies, to provide cooling and electricity to the building. The bay assemblies can be modified as needed to provide cutouts for piping and electrical cables as needed and described below.

If the building in which the bay assembly is being installed in, is being newly constructed, building plans can take the installation of the bay assemblies into account, and save on the cost of materials that would need to be removed in existing construction, such as shingles or siding, sheathing, weather barriers, and vent structures. This is only possible since the bay assemblies as disclosed herein are being structurally integrated into the building. Known solar systems in contrast provide no savings in new construction since they are only cosmetically integrated into an outer most layer of a building such as shingles or siding.

Furthermore, for installation on existing roofs, the bay assembly replaces roofing materials such as plywood sheathing, shingles, proper vent and weatherproofing, and replaces this existing weight. In other words, the installation of the presently disclosed bay assembly does not add to the weight of an existing roof and does not change the structural integrity of a code-compliant roof, or only adds a minimal amount compared to the installation of known solar systems, thereby reducing or eliminating the need for additional structural support, reinforcement or renovation of old or existing roofs prior to installation. Thus, the cost for installation of the present bay assembly on both new construction and old or existing roofs is greatly reduced as compared to the installation of known systems.

The present bay assembly allows for the installation of different solar products such as a heater, cooler and photovoltaic panels. A combination of these various solar products can be installed in the bay assemblies in a single building having various solar products installed. Furthermore, when repairs are needed such as roof repairs, or siding repairs, the entire bay assembly does not need to be uninstalled. If the solar products housed in or within the bay assemblies need to be repaired or replaced, the bay assembly does not need to be removed, and the internal components can be easily replaced, repaired and reinstalled. In some embodiments, a solar heater can be swapped out for a cooler or photovoltaic panel with thermal backing plate using the same bay assembly. The entire bay assembly is also fully recyclable.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a front perspective view of a typical house section.

FIG. 2 is a top perspective view of an embodiment of a bay assembly showing its parts exploded and assembled.

FIG. 3A is a top perspective view of the glass frame being slidably connected to the tray of the bay assembly.

FIGS. 3B and 3C are side perspective views of the frame being slidably connected to the tray of the bay assembly.

FIG. 4 is a top perspective view of the bay assembly as shown in FIG. 1, and an embodiment of a solar heater showing its parts in an exploded view.

FIGS. 5A and 5B show partial cross-sectional views of the glass frame pieces and tray of the bay assembly.

FIG. 5C shows a partial bottom view of the bay assembly.

FIG. 6A shows a perspective view of a top holder for the evacuated tubes.

FIG. 6B shows a perspective view of a bottom holder for the evacuated tubes.

FIG. 6C shows an alternate embodiment of the tray of the bay assembly.

FIG. 6D shows the embodiment of the tray as shown in FIG. 6C with an evacuated tube and the tube holders installed in the tray.

FIG. 6E shows a partial view of the tray with evacuated tubes and top holder installed.

FIG. 6F shows a partial view of the tray with evacuated tubes and bottom holder installed.

FIG. 7A is a top perspective view of an embodiment of a water manifold.

FIG. 7B is a top perspective view of an embodiment of a solar blanket in a closed and open position.

FIGS. 7C and 7D are a back and front perspective view of an assembly of the water manifold and solar blanket shown in FIGS. 7A and 7B, respectively.

FIG. 8 is a side cross sectional view of an embodiment of an evacuated tube and water manifold assembled together.

FIG. 9 is a top perspective view of the bay assembly and solar heater as shown in FIG. 4, with the solar heater assembled and housed in the bay assembly shown in an open and closed position.

FIG. 10 is a top perspective view of an embodiment of the bay assembly shown with an embodiment of a solar cooling panel, with the bay assembly shown in an open and closed position.

FIG. 11A is a top perspective view of an embodiment of the bay assembly shown with an embodiment of a combined photovoltaic and thermal backing plate system, with the bay assembly shown exploded.

FIG. 11B is a top perspective view of an embodiment of the bay assembly shown with an embodiment of a combined photovoltaic with thermal backing plate system shown assembled.

FIG. 12 is a top perspective view of embodiments of the bay assembly shown housing embodiments of the solar cooling plate, photovoltaic with thermal backing plate system, and solar heater.

FIG. 13 is a top perspective view of an embodiment of the bay assemblies shown housing solar heaters, with side and center hold down bars, snap covers for the hold down bars and flashing.

FIGS. 14A and 14B are a partial perspective view and a side cross sectional view of a side hold down bar, snap cover and flashing in an exploded view and shown assembled, respectively.

FIG. 14C is a side cross sectional view of a center hold down bar.

FIG. 14D is a top perspective view of the glass frame and an embodiment with the hold down bars having weatherproofing tape.

FIG. 14E is a perspective view of the glass frame and an embodiment with the hold down bars having weatherproofing tape as shown in FIG. 14D.

FIG. 15 is a top perspective exploded view of an embodiment of the bay assemblies shown housing solar heaters, with side and center hold down bars, snap covers and flashing, with roof rafters shown underneath.

FIG. 16 is a side cross sectional view of a center hold down bar and rafter, and a partial cross-sectional view of bay assemblies with the center hold down bar being attached to the roof rafter.

FIG. 17A is a top perspective view of an embodiment of the bay assemblies shown housing solar heaters, with the hold bars shown attached to the rafters, and the snap covers covering the hold down bars.

FIG. 17B is a top perspective view of an embodiment of the bay assemblies shown housing solar heaters, with the snap covers covering the hold down bars and a top flashing covering the top portion of the assembly when installed on a building.

FIG. 17C is a partial side cross sectional exploded view of the top flashing and bay assembly and a side partial cross-sectional view of a top portion of the bay assembly with the top flashing attached.

FIG. 17D is a partial side cross sectional exploded view of the bottom frame and glass panel and a side partial cross-sectional view of the bottom frame and the bay assembly when installed.

FIG. 17E is a partial side cross sectional view of the bay assemblies shown installed on an existing roof.

FIG. 18 is a perspective view of a typical house section shown with bay assemblies housing solar heaters installed in the roof and wall, with typical building components shown in an exploded view.

FIGS. 19A and 19B show a side cross sectional view of a typical house section with assemblies housing solar heaters installed in the roof and wall.

FIGS. 20A and 20B show the installation process of the bay assembly on an existing roof.

FIGS. 20C, 20D and 20E show bay assemblies housing solar heaters installed in roofs with rafters having different on center spacings.

### DETAILED DESCRIPTION

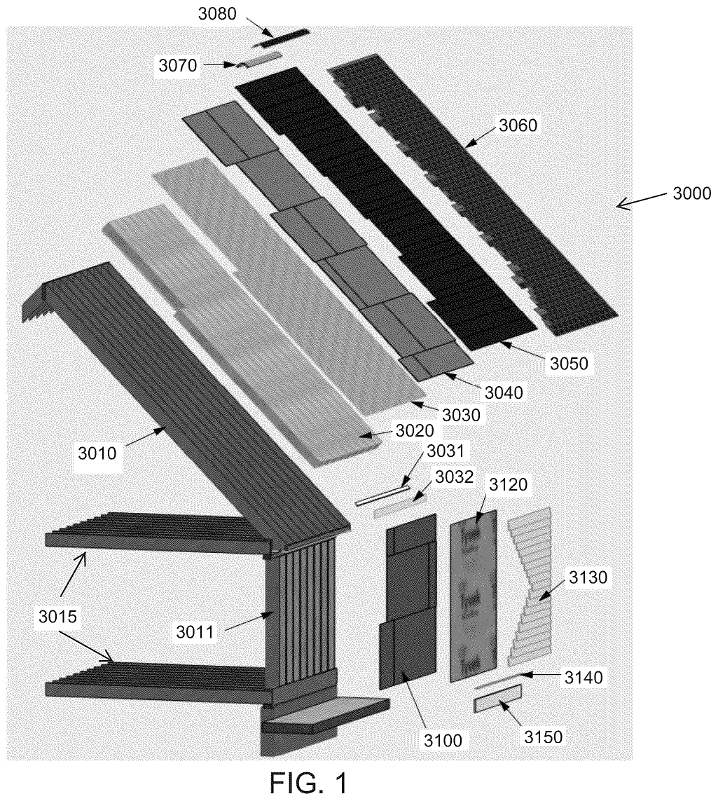

Referring to the drawings and in particular to FIG. 1, a typical building 3000 is shown with typical building components shown in an exploded view. Rafters 3010 provide support and structural integrity to the roof. Insulation 3020 is provided between the rafters 3010 to insulate the attic. A corrugated structure or vent 3030 can be installed below the sheathing 3040 and can maintain at least a one-inch gap between the sheathing and insulation to accommodate airflow from the soffit air intake (located adjacent to the facia board 3032) to the ridge vent 3070 located below the ridge roofing cap 3080. The roof drip edge 3031 is located adjacent the facia board 3032. A gap between insulation 3020 and sheathing 3040 helps maintain airflow from the air intake to the ridge vent to ventilate the attic space. Sheathing, such as plywood sheathing 3040, is connected to the rafters, with the barrier or ice/water shield 3050 installed above the sheathing. Shingles 3060 are installed above the barrier 3050 as the exterior layer.

Wall studs 3011 provide structural integrity to the walls of the building. Sheathing 3100 is connected or attached to the studs, with barrier 3120 connected or attached on top of the sheathing 3100, and the clapboard or siding 3130 connected or attached on top of the barrier 3120. The drip cap 3140 and the skirt board 3150 are located at the base of the wall. Floor joists 3015 are structural members used in framing and supporting the building as shown.

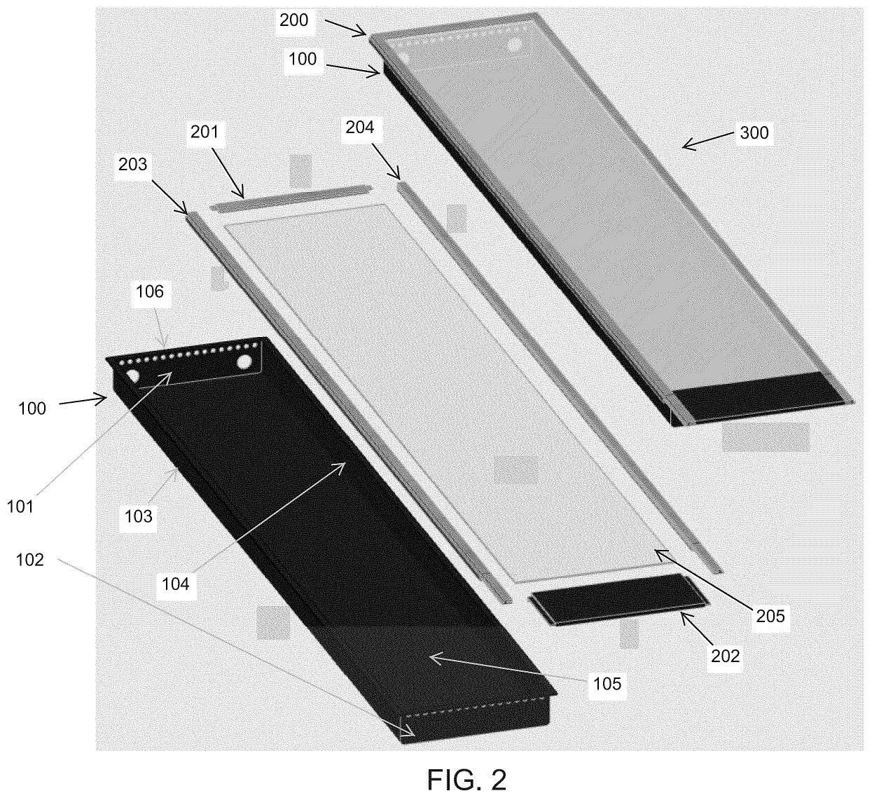

Referring to FIG. 2, a bay assembly 300 is shown. Bay assembly 300 includes a tray 100 and glass frame 200 which includes glass panel 205. Glass frame 200 is connectable to tray 100 to form the bay assembly 300. Tray 100 has sides 101, 102, 103 and 104 as shown, with bottom side 105, joined together or integrally formed as shown. Tray 100 can form a rectangular shape as shown. The top portion of tray 100 has a protrusion or lip 106 that runs along the entire top perimeter of tray 100 as shown. Glass frame 200 includes glass panel 205 that is a sheet of glass, and includes top frame 201, bottom frame 202, and side frames 203 and 204. Frames 202, 203 and 204 have a first and second groves 211 and 212 that run along the entire inside length of each frame piece. Frame 201 only has one or first groove 211. The first groove 211 is for accommodating and holding glass panel 205, and the second lower groove 212 is for accommodating and holding onto lip 106 located on tray 100. Frames 201, 202, 203 and 204 are held together by interlocking protrusions 206 and grooves 211 and 212, and adhesive. Tray 100 can be made of plastic, aluminum, or other lightweight materials, and glass frame 200 can be made from metals, such as but not limited to aluminum, copper, brass, tin and steel. In some preferred embodiments, tray 100 is made of plastic, and can be made of other materials. In some embodiments, tray 100 is stamped aluminum. In some embodiments, tray 100 is extruded aluminum. In some embodiments, tray 100 is a stamped metal or an extruded metal. In some embodiments, tray 100 can be lined with a solar film that increases the reflection of light within the tray, and thereby increases the efficiency of the solar heater. In some embodiments, the solar film can be held in place by rivets on either side of the tray. In some embodiments, the outside facing side of glass 205 can be of a rough texture, and the inside facing side of the glass 205 can be smooth, so that the internal components installed in the tray are not easily viewed from outside the assembly. In some embodiments, glass 205 can be a Fresnel lens or other glass with light concentration characteristics that improves the efficiency of the solar heater by focusing solar radiation on the evacuated tubes. In some embodiments, glass 205 is a tempered glass.

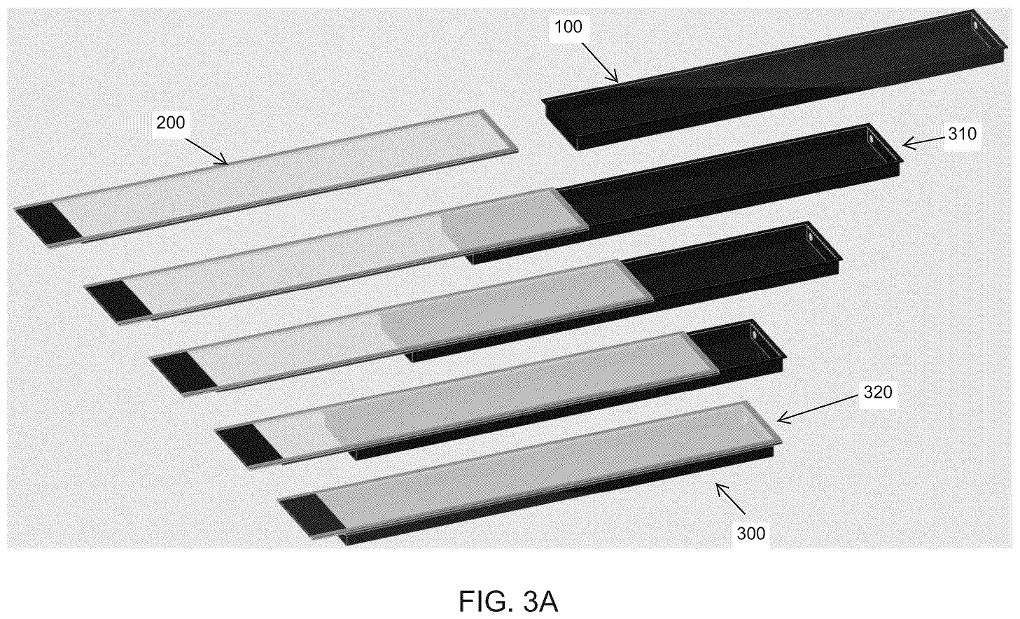

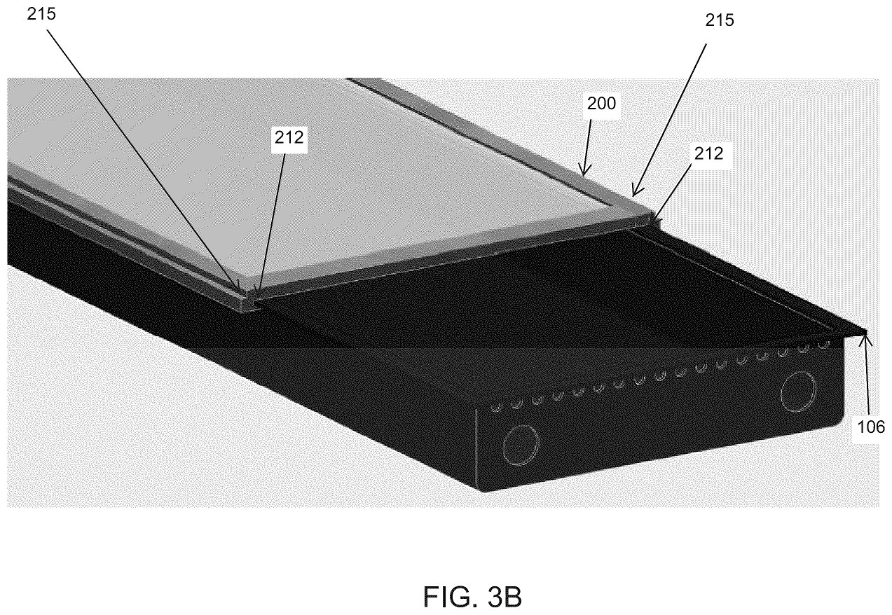

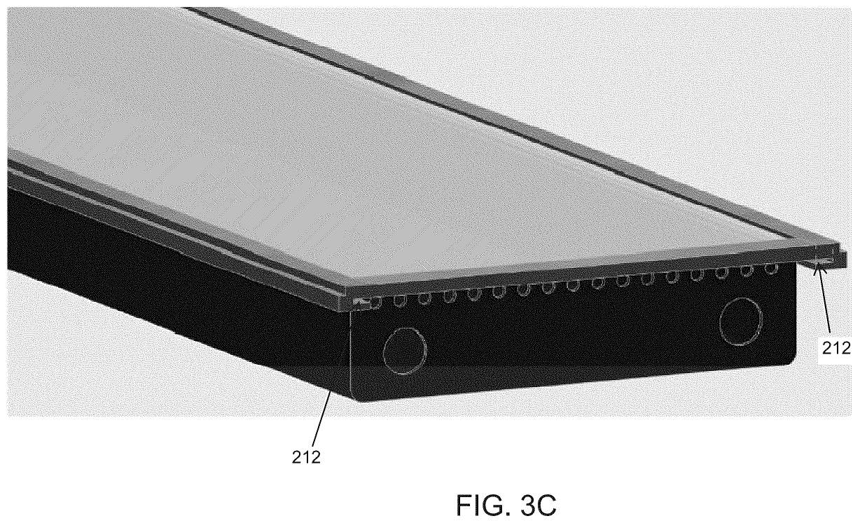

Referring to FIG. 3A, when glass frame 200 is assembled, and groove 212 is aligned with lip 106, glass frame 200 can slid onto and connected or attached to tray 100, from position 310 to position 320 as shown. FIGS. 3B and 3C show the glass frame 200 sliding along lip 106 from a different viewpoint. Once glass frame 200 is completely slid onto and connected to tray 100, bay assembly 300 is installed so that frame 202 is oriented at the bottom of the bay assembly 300 when connected to rafters on the roof, or studs on the wall. Frame 200 can only be slid onto the tray starting at groove 212 under top frame 201, and frame 202 prevents the frame 200 from sliding further. Frames 201-204 are further described below.

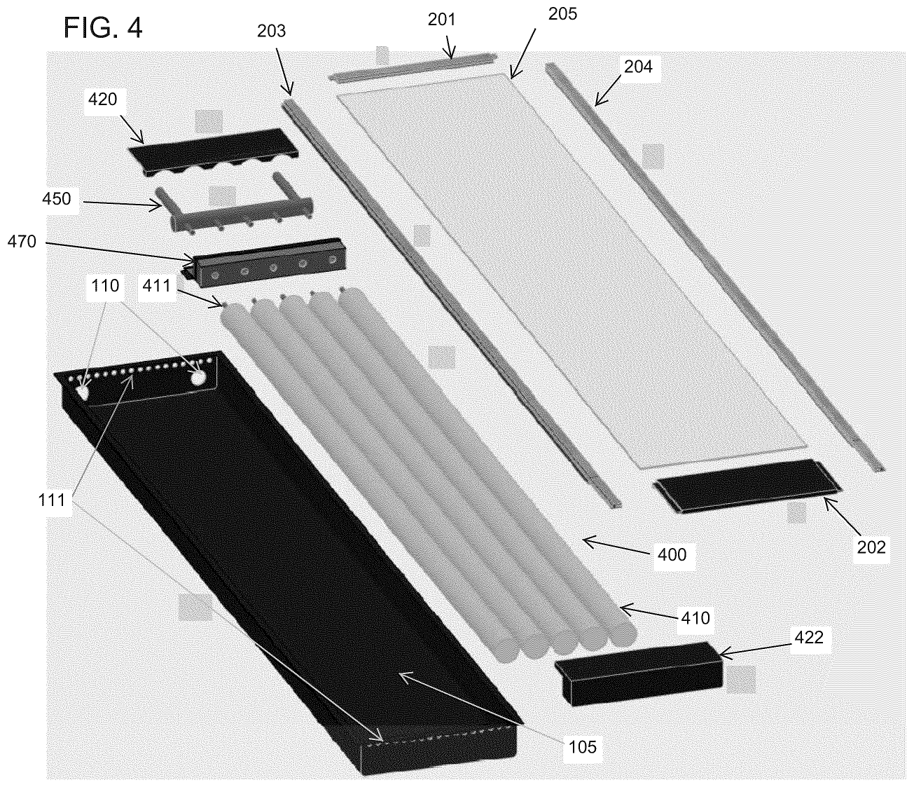

Referring to FIG. 4, a solar heating device 400 is shown disassembled. Solar heating device 400 includes in some embodiments at least one evacuated tube 410, with a heat conducting rod 411 running through the center of tube 410 and having a protrusion at one end of the tube 410. In some embodiments, there can be multiple tubes 410 housed in tray 100. FIG. 4 shows an embodiment of the solar heating device 400 with five tubes 410. Tray 100 can house one, two, three, four and more tubes 410. Rod 411 can be made of metal such as, but not limited to, copper. In some embodiments, rod 411 can be made of metals known for their heat transfer properties such as but not limited to copper.

Water manifold 450 connects to tubes 410 via rod 411 and conveys heat from the tubes 410 to water flowing through the manifold 450. Solar blanket 470 houses water manifold 450 and insulates both the one or more rods 411 and the manifold 450. The one or more tubes 410 are held down by a top tube holder 420 and a bottom tube holder 422 to ensure the one or more tubes 410 remain secure in tray 100.

Tray 100 can include one or more cutouts 110 to accommodate wiring and/or plumbing for the particular solar device housed in tray 100. The tray 100 as shown in FIG. 4 has two holes 110 for a return line and supply line for the water manifold on top side 101. Tray 100 can also include ventilation hole or holes 111 to vent the bay assembly 300 and provide airflow through the assembly. Hole or holes 111 can be circular in shape, or any other shape that enables venting of the tray 100. Holes 111 can run along the entire length of side 101 and 102 to enable airflow from side 102 through side 101. The size of the holes 111 can be varied depending the need for ventilation. In some embodiments, no holes 111 are present in the tray 100 when there is no need for ventilation.

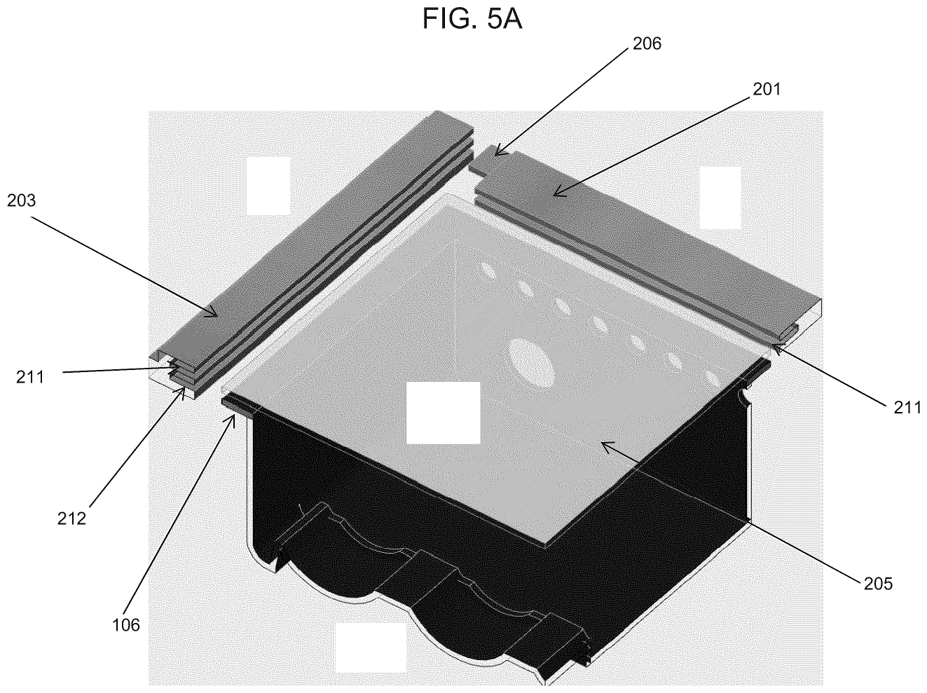

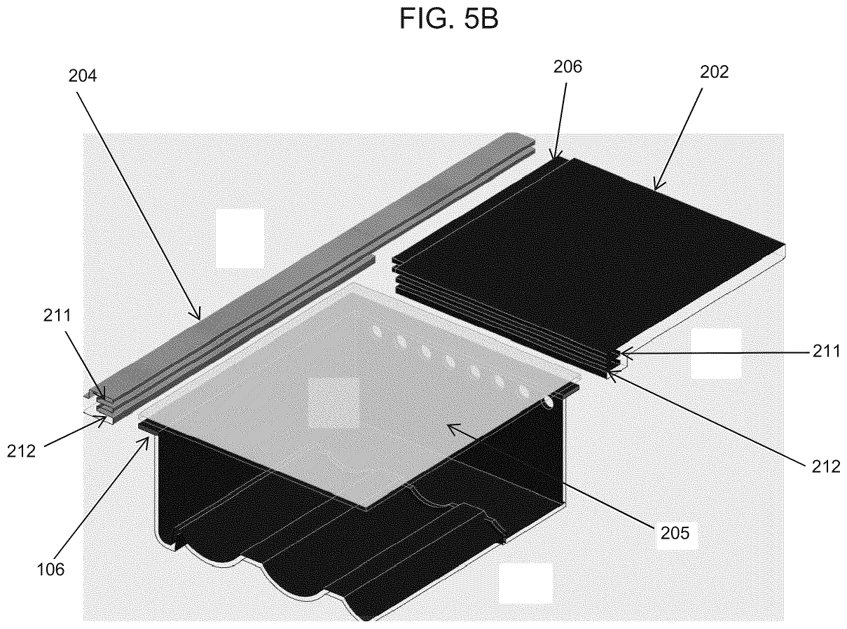

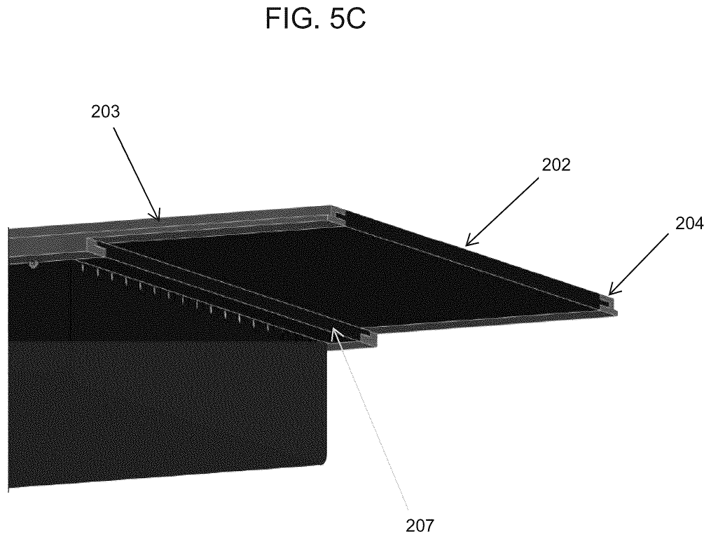

Referring to FIG. 5A, a partial cross section of tray assembly 100 is shown with portions of top frame 201 and side frame 203. Top frame 201 only has one groove 211 to accommodate glass 205. Side frame 203 and 204 have two grooves 211 and 212, for accommodating glass 205 and the tray lip 106, respectively. Top frame 201 has a single protrusion 206 on each side of the frame, that interlocks with groove 211 on frames 203 and 204.

Referring to FIG. 5B, a partial cross section of tray assembly 100 is shown with portions of bottom frame 201 and side frame 204. Bottom frame 202, and side frames 203 and 204 have two grooves 211 and 212, for accommodating glass 205 and the lip 106, respectively. Bottom frame 202 has a double protrusion 206 on each side of the frame, that interlocks with grooves 211 and 212 on frames 203 and 204. The lower protrusion 206 that interlocks with groove 212 is not the full length of the top protrusion 206 that interlocks with groove 211 as shown in FIG. 5C.

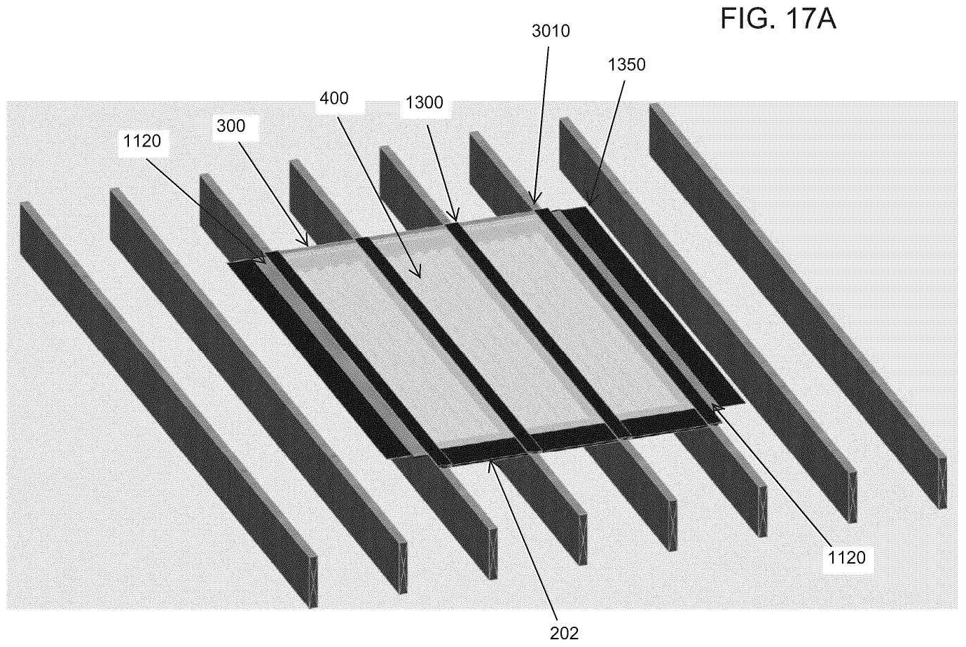

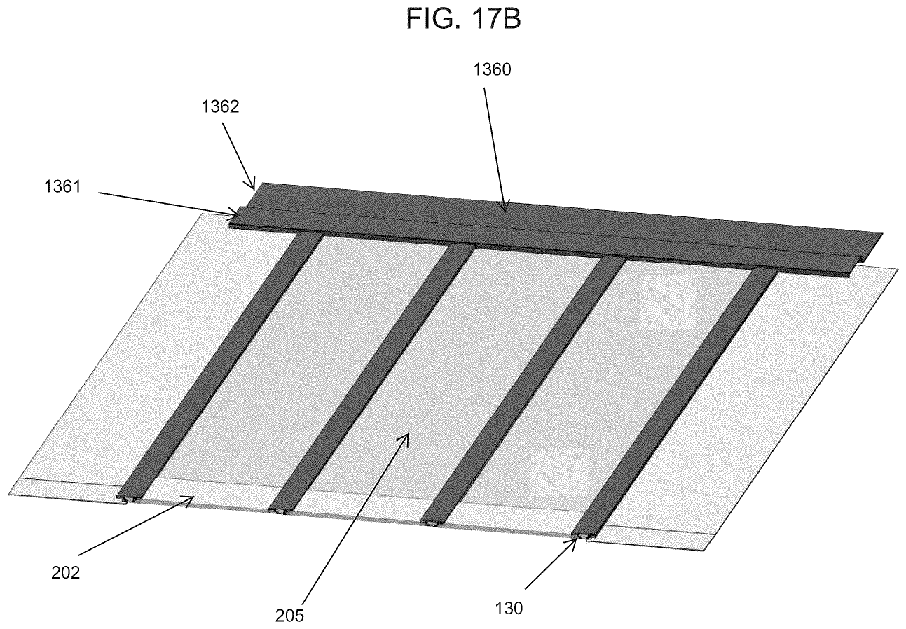

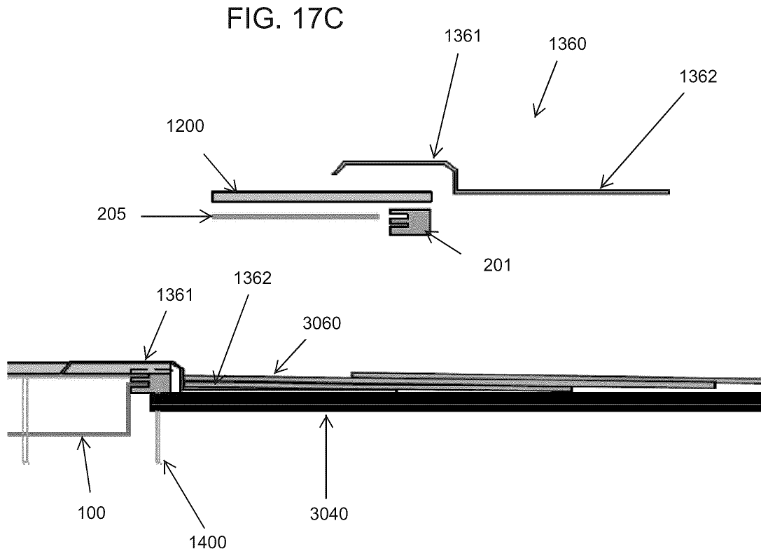

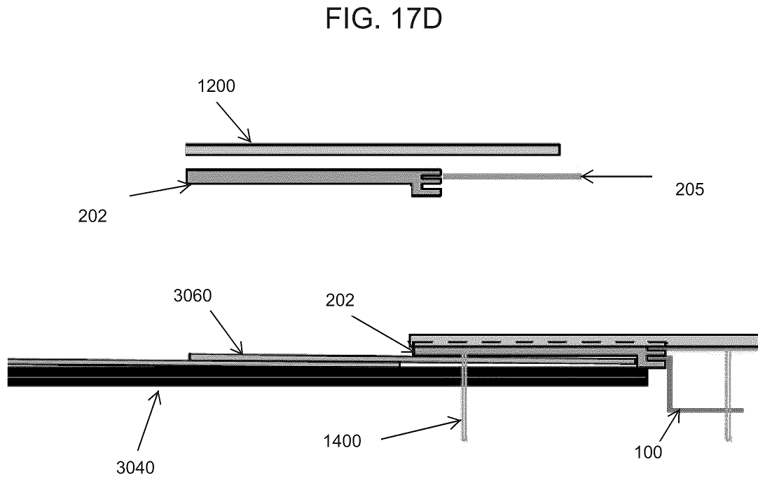

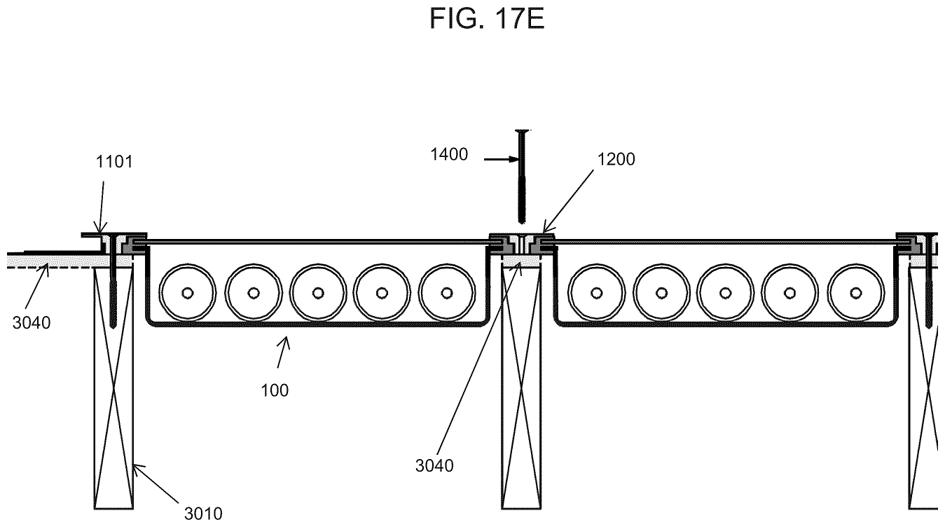

Referring to FIG. 5C, a bottom partial perspective view of tray assembly 100 is shown. Bottom frame 202 has a protrusion 207 on the outer bottom portion of frame 202. Protrusion 207 in conjunction with the adjacent portions of frames 203 and 204 can rest on top of the plywood 3040 of the roof that surrounds the cutouts made to accommodate the tray assembly 100 as shown in FIG. 17D. As shown in FIG. 5C, frames 203 and 204 have a lower portion that does not have a groove 212.

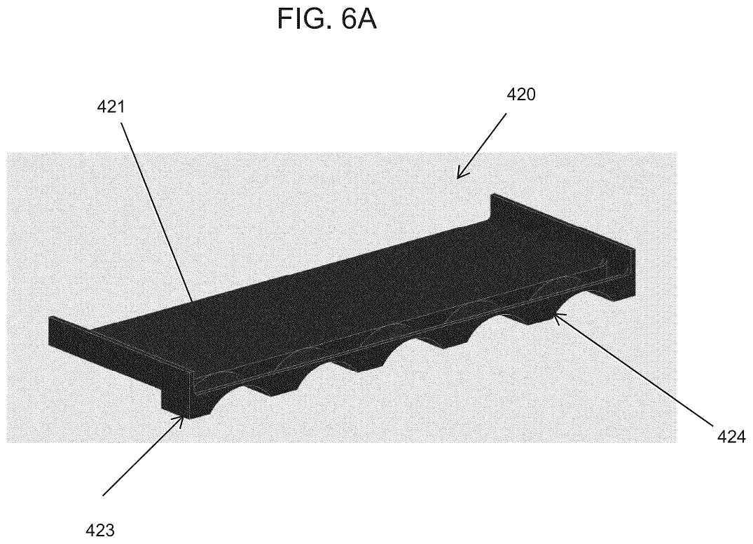

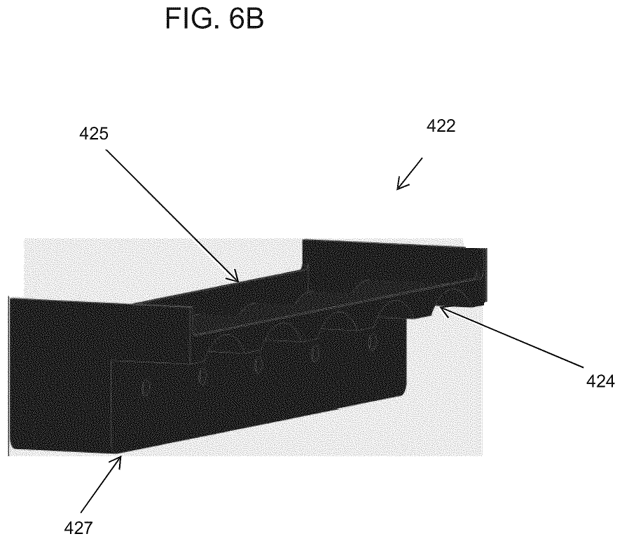

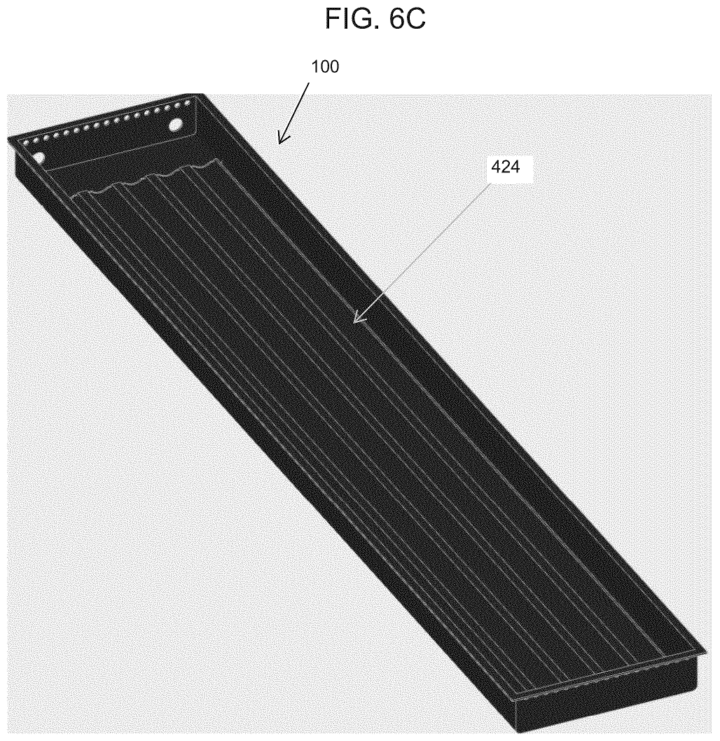

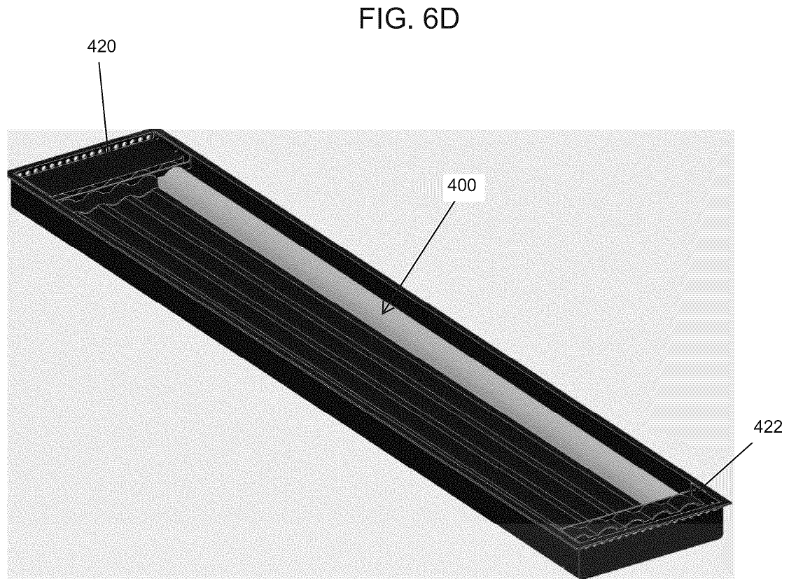

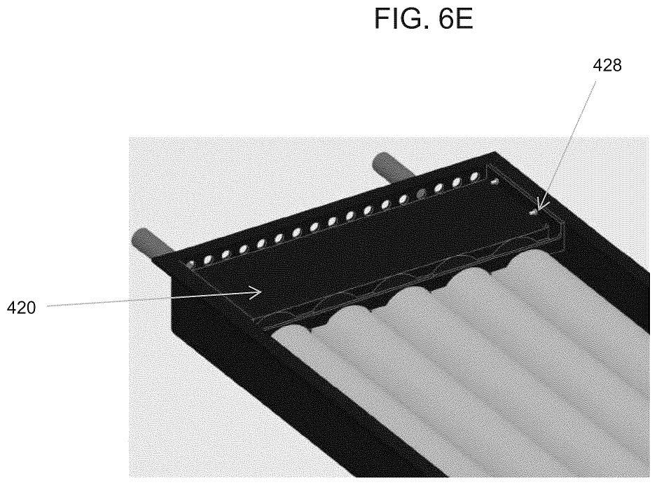

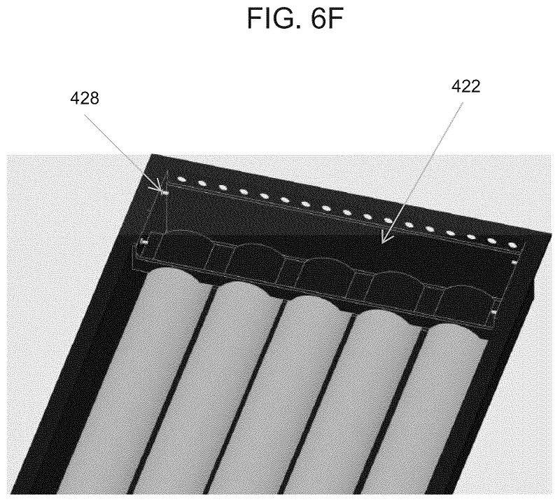

Referring to FIG. 6A, a top holder 420 is shown, with a top surface 421, and a bottom surface 423. Top holder 420 has semicircular grooves 424. The number of grooves 424 will match the number of tubes 410 housed in tray 100. Top holder 420 is installed in tray 100 to keep tubes 410 from moving and will cover the solar blanket 470 as well.

Referring to FIG. 6B, a bottom holder 422 is shown, with a top surface 425, and a bottom surface 427. Bottom holder 422 has semicircular grooves 424. The number of grooves 424 will match the number of tubes 410 housed in tray 100. Bottom holder 420 is installed in tray 100 to keep tubes 410 from moving.

Referring to FIG. 6C, an alternative embodiment of tray 100 is shown having semicircular grooves 424. The number of grooves 424 will match the number of tubes 410 housed in tray 100. Grooves 424 in tray 100, and/or in top and bottom holders 420 and 422 help secure tubes 410 in tray 100 and prevent them from moving. In some embodiments, grooves 424 in tray 100 add to the rigidity and stability of the tray 100.

Referring to FIG. 6D, top and bottom holders 420 and 422 are installed in tray 100 and secure a tube 410 to the tray. Tube 410 also rests in groove 424 in tray 100 on a bottom surface of the tube. Grooves 424 on top and bottom holders 420 and 422 help secure the tube 410 and prevent it from moving in the tray. In some embodiments, top and bottom holders 420 and 422 can be used with a tray 100 that does not have grooves 424.

Referring to FIG. 6E, the top holder 420 is shown installed in tray 100. Bolts and/or screws 428 can be used to removably secure the holder 420 in tray 100 as shown.

Referring to FIG. 6F, the bottom holder 422 is shown installed in tray 100. Bolts and/or screws 428 can be used to removably secure the holder 422 in tray 100 as shown.

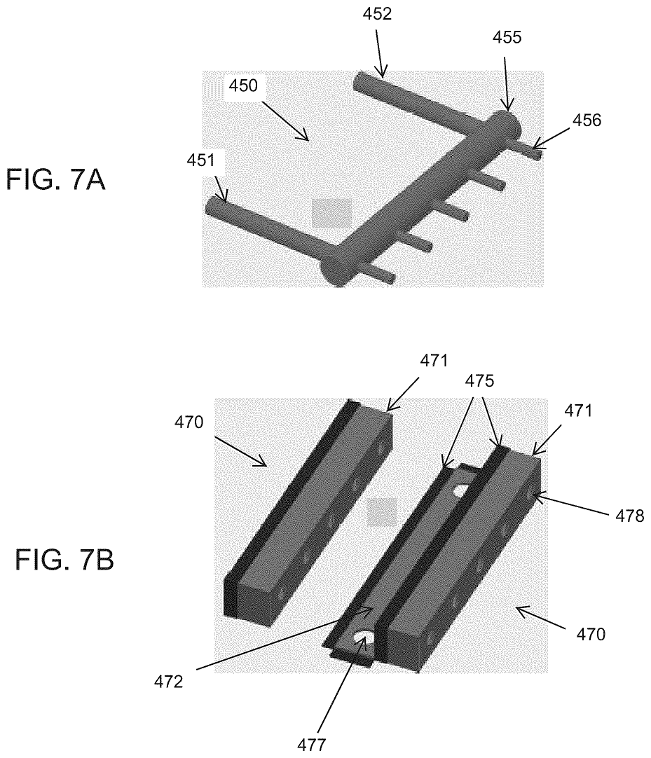

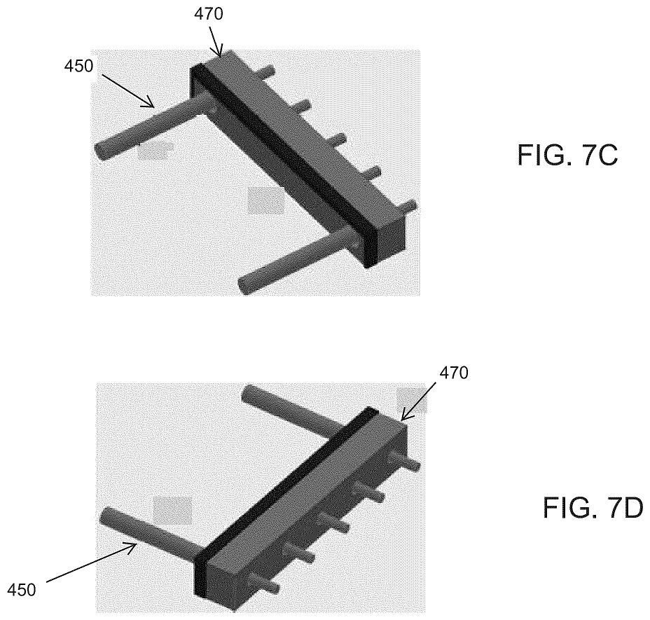

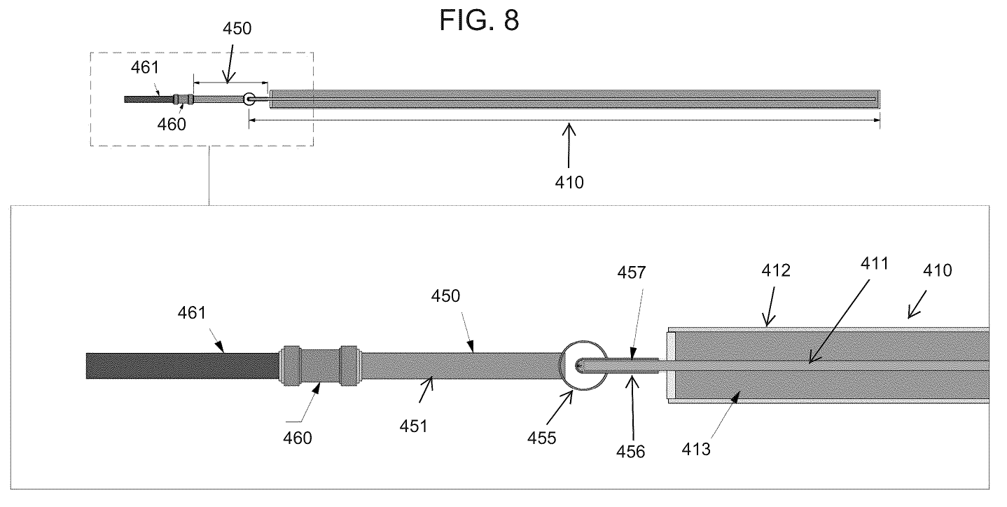

Referring to FIG. 7A, water manifold 450 is shown which has a water supply/feed line 451, and a water return line 452, chamber 455 that connects the supply line 451 to the return line 452, and hollow cylindrical protrusions 456 that can accommodate a portion of rods 411. The number of hollow cylindrical protrusions 456 will match the number of tubes 410 housed in tray 100. Chamber 455 and return and supply lines 451 and 452 can be hollow tubes, and can be made of metal, such as, but not limited to, copper. In some embodiments, chamber 455, supply lines 451 and 452 can be made of metals known for their heat transfer properties such as but not limited to copper. As shown in FIG. 8, hollow cylindrical protrusions 456 can extend into the middle of chamber 455 and are closed off at the end, and therefore do not allow water from lines 451 and 452 to exit through the protrusions 456. In other words, water enters through line 451, into chamber 455 and exits through line 452 (or can flow in the opposite direction) and does not exit through protrusion 456 as shown.

Referring to FIG. 7B, solar blanket 470 has a front portion 471 facing tubes 410, and rear portion 472 facing supply and return lines 451 and 452, when water manifold 450 is placed in the solar blanket. Solar blanket 450 has holes in portion 472 to accommodate lines 451 and 452, and holes 478 to accommodate protrusions 456. The number of holes 478 will match the number of protrusions 456 and number of tubes 410. Front portion 471 and rear portion 472 can be connected together by fasteners such as a hook and loop, or other types of fasteners 475. Solar blanket 470 can also be constructed from other materials with thermal insulation properties.

FIGS. 7C and 7D show the water manifold 450 housed in the solar blanket 470, with the fasteners 475 connecting the front portion 471 and rear portion 472 together.

FIG. 8 shows a side cross sectional view of an evacuated tube 410 connected to water manifold 450 via the insertion of rod 411 into hollow cylindrical protrusion 456. Thermal paste 457 can sit between rod 411 and the inner surface of hollow protrusion 456. Supply line 451 is connected to water supply piping 461 by a coupling or attachment, such as shark bite 460, similarly return line 452 is connected to hot water return piping 462 by a coupling or attachment, such as shark bite 460. Tube 410 has an outer wall 412, and an empty evacuated chamber 413 through which rod 411 extends through as shown. In some embodiments, outer wall 412 is double sided glass wall that can have a vacuum between the glass walls, or an inert gas. In some embodiments, rod 411 can be in a fin structure in the tube 410 for greater heat transfer. In some embodiments, cool or supply water is supplied by line 461 through attachment 460, into supply line 451, then into chamber 455, and is heated by rods 411, and then passes through return line 452 and through attachment 460 and out through return line 462. In this way, the water is heated by solar heater 400, and then piped through the house as needed for various purposes. In some embodiments, a third-party heating system can be accommodated in the bay assembly, which can include evacuated tubes.

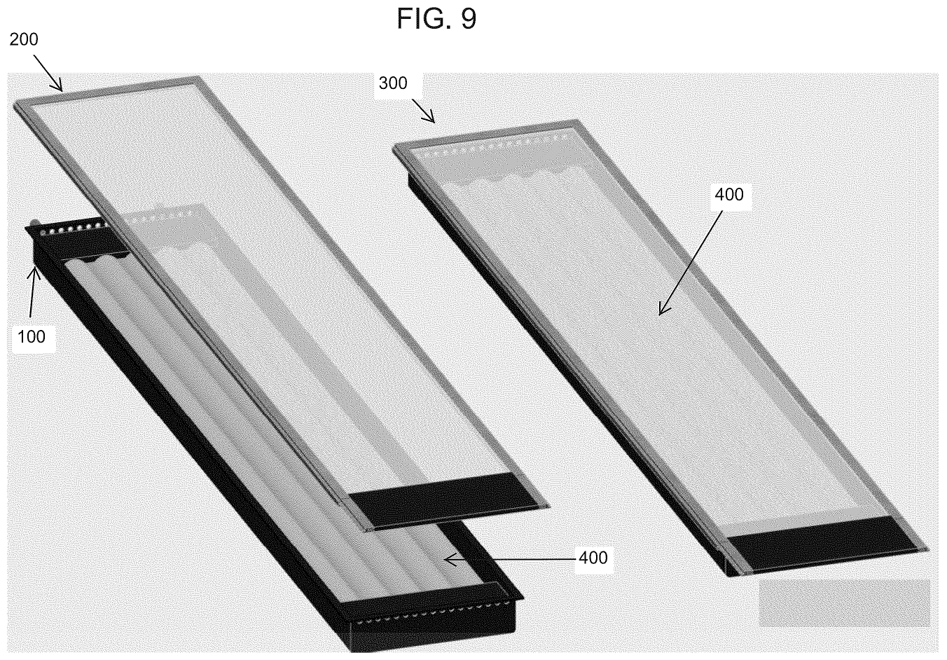

Referring to FIG. 9, solar heater 400 is shown fully assembled and housed in tray 100. Tubes 410 are placed in the tray 100, with top and bottom holders 420 and 422 securing the tubes 410 in tray 100. Top holder 420 also secures solar blanket 470 which houses water manifold 450. Rods 411 are connected to hollow protrusions 456 as described above and shown in FIG. 8. The return and supply lines 451 and 452 extend through holes 110. Holes 111 can be placed into sides 101 and 102 to vent the assembly 300.

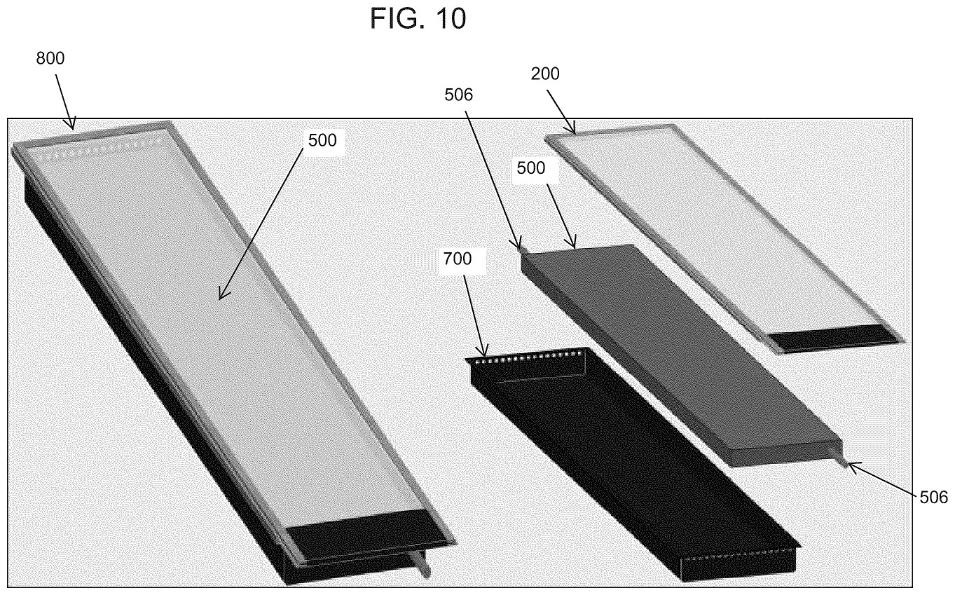

Referring to FIG. 10, tray 700 is identical to tray 100 with the exception of the locations of cutouts 110 being made to accommodate piping 506 for cooling plate 500. Cooling plate 500, in some embodiments, can be a third-party system that is installed in bay assembly 800. Frame 200 is slidably connectable to tray 700 in same manner as to tray 100. Bay assembly 800 includes tray 700 and glass frame 200 and houses cooling plate 500 as shown. Piping 506 enables the flow of coolant into and out of the cooling plate 500. In some embodiments, the flow of heated coolant into and out of the cooling plate enables the heat from the building to be rejected to the cold sky.

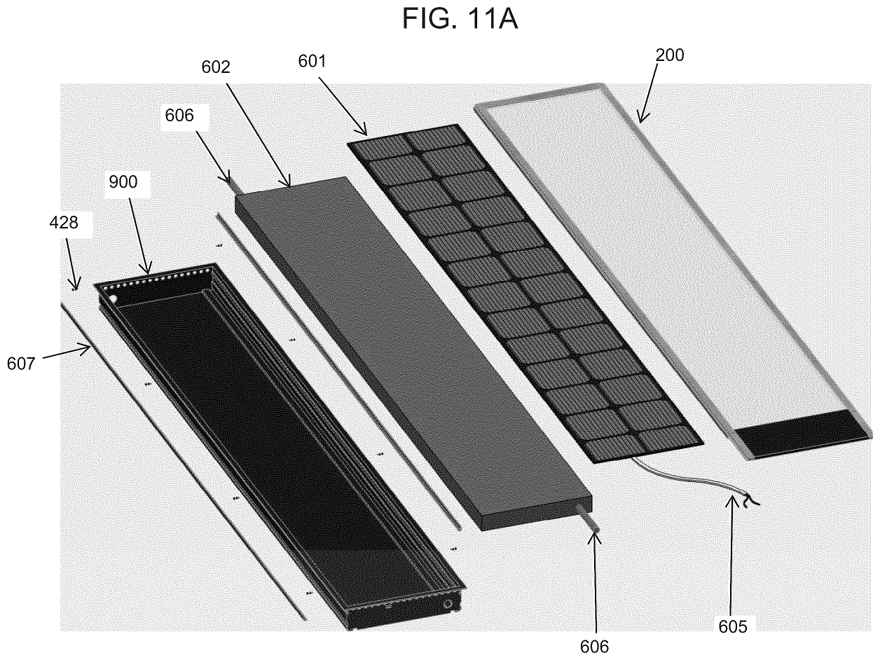

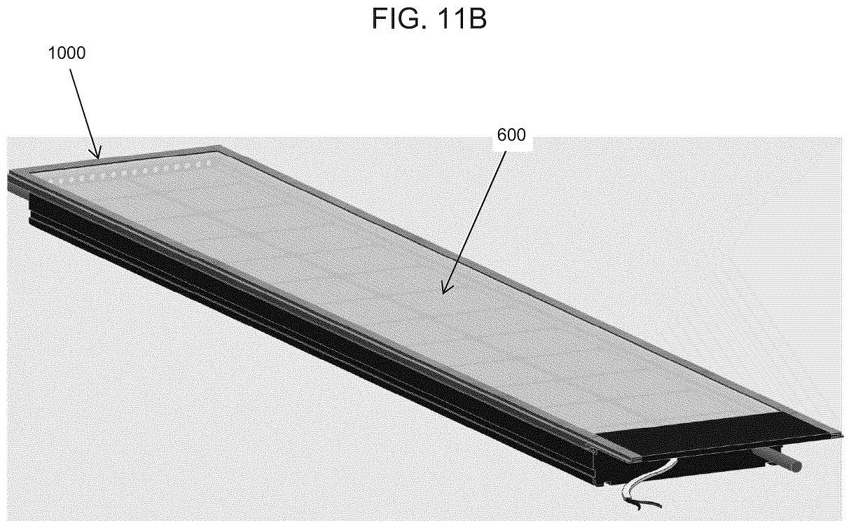

Referring to FIGS. 11A and 11B, tray 900 is identical to tray 100 with the exception of the locations of cutouts 110 being made to accommodate piping 606 for photovoltaic panel 601. Glass frame 200 is slidably connectable to tray 900 in same manner as to tray 100. Bay assembly 1000 includes tray 900 and frame 200, and photovoltaic system 600 as shown. Photovoltaic panel 601 is capable of generating electricity, as needed, that is routed to the building by wire 605, and it is housed in enclosed assembly 1000. Panel 601 is connected at a bottom surface to a thermal backing plate 602 that removes excess heat from panel 601, so as to keep the efficiency of the panel 601 from degrading due to overheating. Piping 606 enables the flow of coolant into and out of the thermal backing plate 602. Photovoltaic panel 601 and thermal backing plate 602, in some embodiments, can be a third-party system that is installed in bay assembly 800. In some embodiments, hold down bars 607 and bolts and/or screws 428 are used to secure the components in bay assembly 1000. Referring to FIG. 11B, assembly 1000 is shown housing system 600.

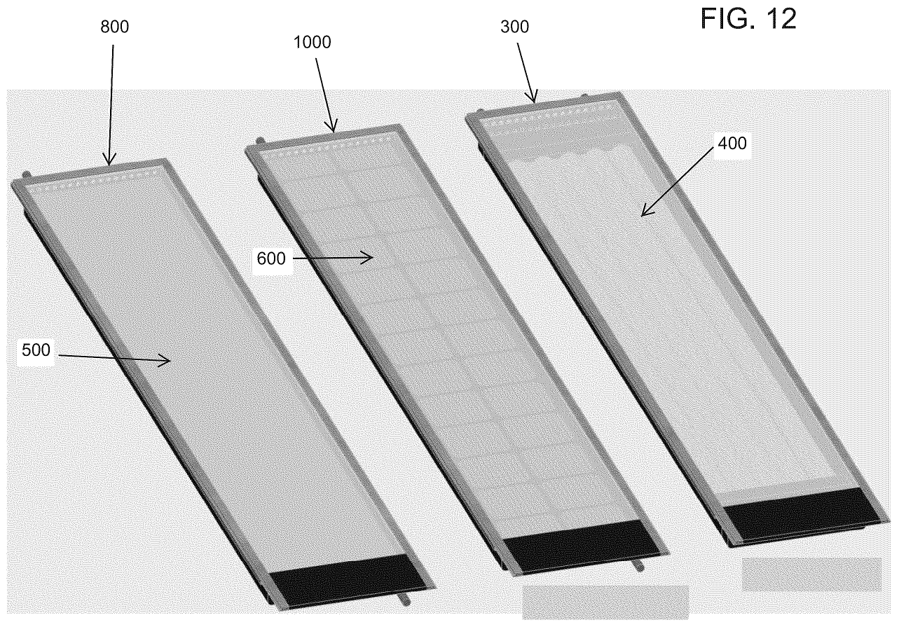

Referring to FIG. 12, bay assemblies 300, 800 and 1000 are shown with panels 200 connected to each tray 100, 700 and 900, each housing solar heater 400, solar cooling plate 500 and a combined photovoltaic with thermal backing plate system 600, respectively, as shown. In some embodiments, bay assemblies 300, 800 and 1000 can be made entirely of stamped metals, such as but not limited to aluminum, steel, copper, brass and tin. In some embodiments, bay assemblies 300, 800 and 1000 can be made entirely of extruded metals, such as but not limited to aluminum, steel, copper, brass and tin. In some embodiments, bay assemblies 300, 800 and 1000 can be made of a variety of materials such as plastics and metals.

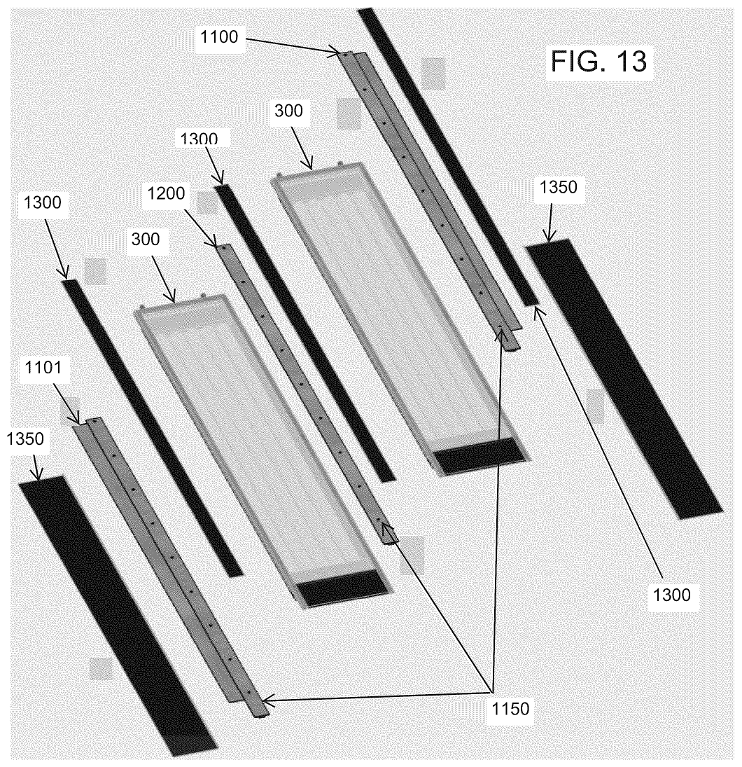

Referring to FIG. 13, a center hold down bar 1200 and left side and right side hold down bars 1101 and 1100 are shown, respectively. Center hold down bar 1200 is used to hold down bay assemblies such as assemblies 300, 800 and 1000, and is used between two adjacent bay assemblies so that the center of the hold down bar 1200 is connected to a rafter, such as a rafter 3010, and connects both assemblies on either side of the hold bar to the rafter. Left and right hold down bars 1101 and 1100 are similar to center hold down bar 1200 but are only used on the leftmost bay assembly and right most bay assembly when more than one assembly is installed together. In some embodiments, hold down bars 1100, 1101 and 1200 can be made entirely of stamped or extruded metals, such as but not limited to aluminum, steel, copper, brass and tin.

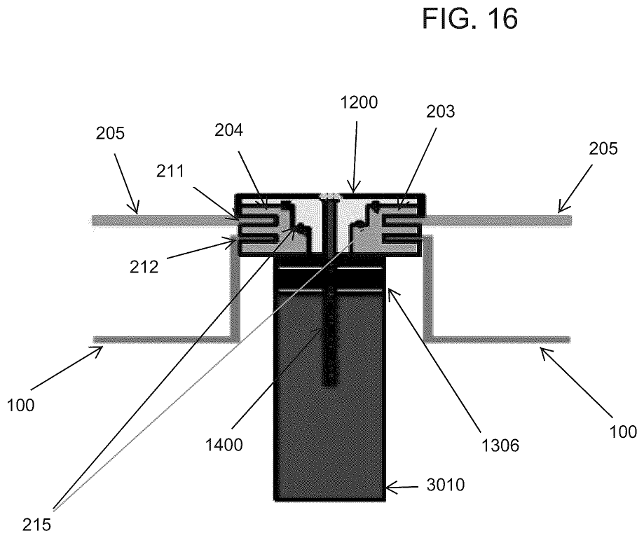

In the example shown in FIG. 13, the left hold down bar 1101 is used to hold down the left side of the assembly 300 on the left, the center hold down bar 1200 is used to hold down both bay assemblies 300 shown, and right most hold bar 1101 is used to hold down the right side of the right most bay assembly 300. When only one bay assembly is being installed, only a right and left hold bar 1100 and 1101 would be used, and no center hold bar 1200 would be utilized. The hold down bars, 1200, 1100 and 1101 are able to hold down the assemblies 300, 800 and 900 by being connected to the rafters 3010 by bolts 1400 driven through holes 1150, as shown in FIG. 16. When bolts 1400 are used to secure the hold down bars to the rafters, the hold down bars exert force on the glass frame 200, and specifically side frames 204 and 203, so that the bay assemblies are unable to move and are retained between the rafters. Hold down bars 1100, 1101 and 1200 can be made of metal or other materials, such as, but not limited to, aluminum.

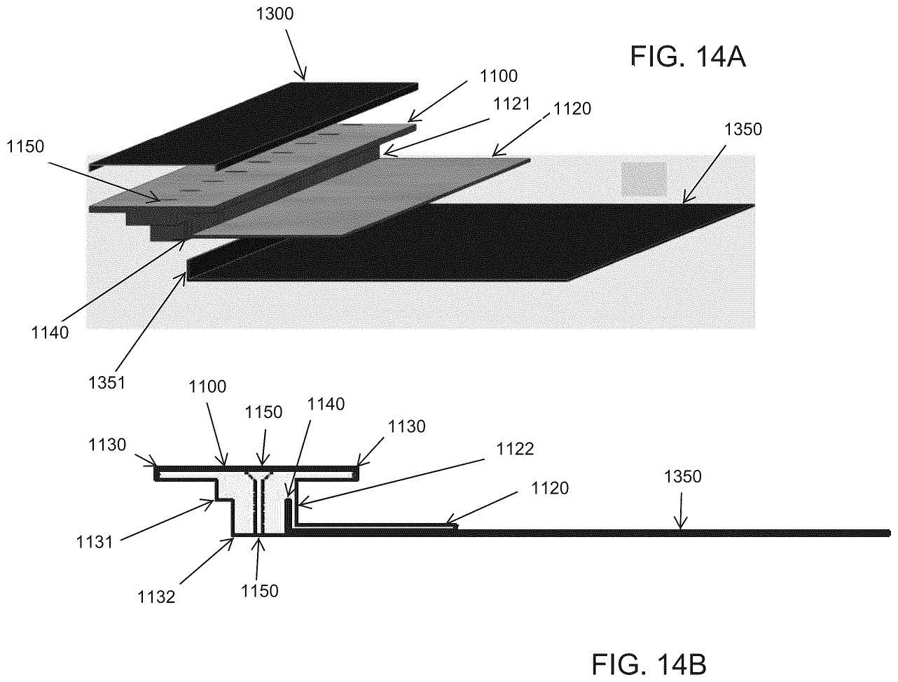

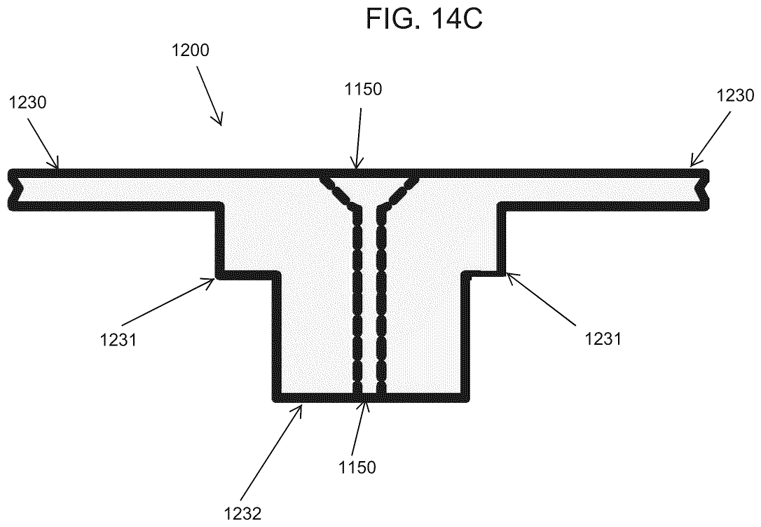

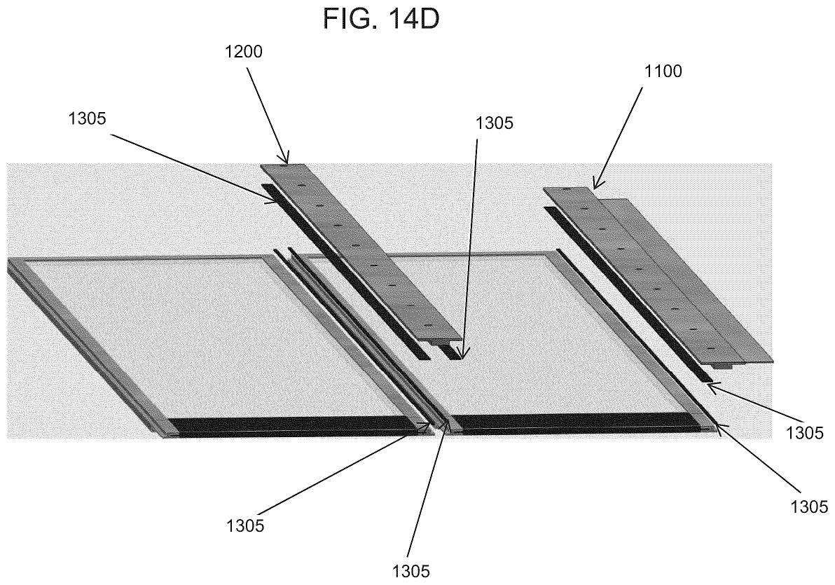

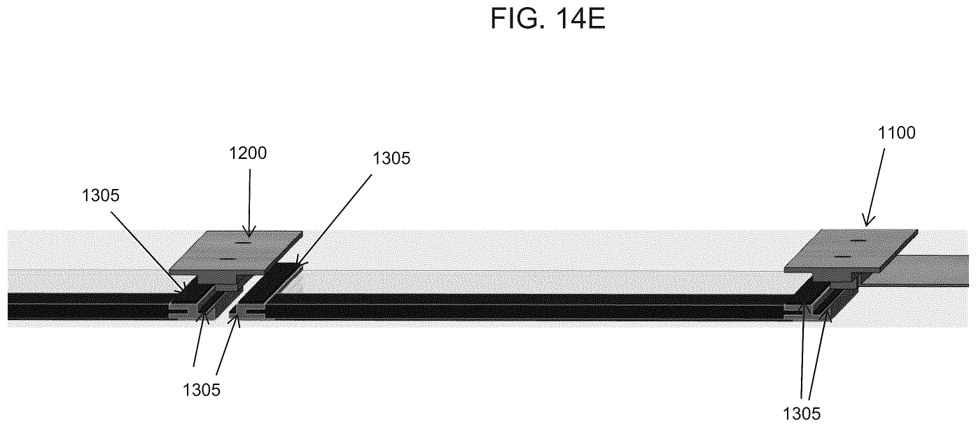

Bay assemblies that are being installed in walls are similarly held to wall studs 3011 instead of rafters 3010 by the hold down bars. Snap covers 1300 can snap onto and fit over the hold down bars 1200, 1100 and 1101 as a cosmetic cover, and also serve as additional weather proofing to protect the bolts 1400 and holes 1150 from exposure to the elements. Flashing 1350 is used in conjunction with left side and right side hold down bars 1101 and 1100 as shown in FIGS. 14A and 14B and described below. Flashing 1350 aids in weatherproofing the installation of the bay assemblies into roofs or walls, so that moisture, rain, snow or ice cannot enter the roof or wall at the site of the bay assembly installation. Flashing, such as flashing 1360, can also be used at the topmost portion of the bay installation as shown in FIG. 17B and described below.

Referring to FIGS. 14A and 14B, a partial view of right side hold down bar 1100 is shown along with a cross sectional side view of the hold down bar with snap cover 1300 and flashing 1350. Flashing 1350 has a lip 1351 that is at a right angle with respect to the rest of the flashing. Hold down bar 1100 is identical to hold down bar 1101, except that it has a plate 1120 on the right-hand side of the bar 1100, rather than the left-hand side of the bar as shown in bar 1101. Plate 1120 extends from a top of either hold down bar 1100 and 1101 to a length equal to the tray 100. In other words, plate 1120 does not extend all the way down the hold bars 1100 and 1101 as shown in FIG. 13. Plate 1120 connects to either bar 1100 and 1101 at a right angle and forms a recess or groove 1140 between a center portion 1132 and plate 1120. In some embodiments, the surface at which the plate is bent at a right angle and where it connects with bar 1100 or 1101 is not flush with the bottom surface of center portion 1132 and is slightly raised to provide room to connect flashing 1350 at lip 1351 into groove 1140. Hold down bars 1100 and 1101 have overhangs 1130 on each side of the hold bars as shown, that enable the hold down bars to apply force on the top surface of frames 203 and 204. Protrusion 1131 protrudes at a right angle to overhang 1130 and center portion 1132 as shown. Protrusion 1131 fits into an outside groove 215 on either frames 203 or 204 as shown in FIG. 3B, and holds glass frame 200 in place when bolt 1400 is placed through hole 1150 to secure the hold down bar to the rafter or wall stud. Hole 1150 can have a top side that is wider than a bottom side, so that a wider head of bolt 1400 can exert force and be retained in the top side portion of the hole 1150. Hold down bars 1100 and 1101 have recesses 1122 formed underneath overhang 1130 and above plate 1120 as shown. Recess 1122 provides space for shingles to be installed in the recess and below overhang 1130.

Referring to FIG. 14C, a side cross sectional view of center hold down bar 1200 is shown. Center hold down bar 1200 is identical to hold down bars 1100 and 1101, except that it does not have a plate 1120 and does not have a groove 1140. Hold down bar 1200 has overhangs 1230 on each side of the hold down bar as shown. Protrusion 1231 protrudes at a right angle to overhang 1230 and center portion 1232 as shown. Protrusion 1231 fits into an outside groove 215 on either frames 203 or 204 as shown in FIGS. 3B and 16, and holds glass frame 200 in place when bolt 1400 is placed through hole 1150 to secure the hold down bar to the rafter or wall stud. Hole 1150 can have a top side that is wider than a bottom side, so a wider head of bolt 1400 can exert force and be retained in the top side portion of hole 1150.

Referring to FIGS. 14D and 14E, in some embodiments, a weather proofing tape 1305 such as, but not limited to, butyl tape is used between the hold down bars 1200, 1100 and 1101 and frames 203 and 204 as shown. The tape 1305 can improve weatherproofing by preventing outside elements such as rain, snow and ice from entering the bay assemblies or the attic area of the building.

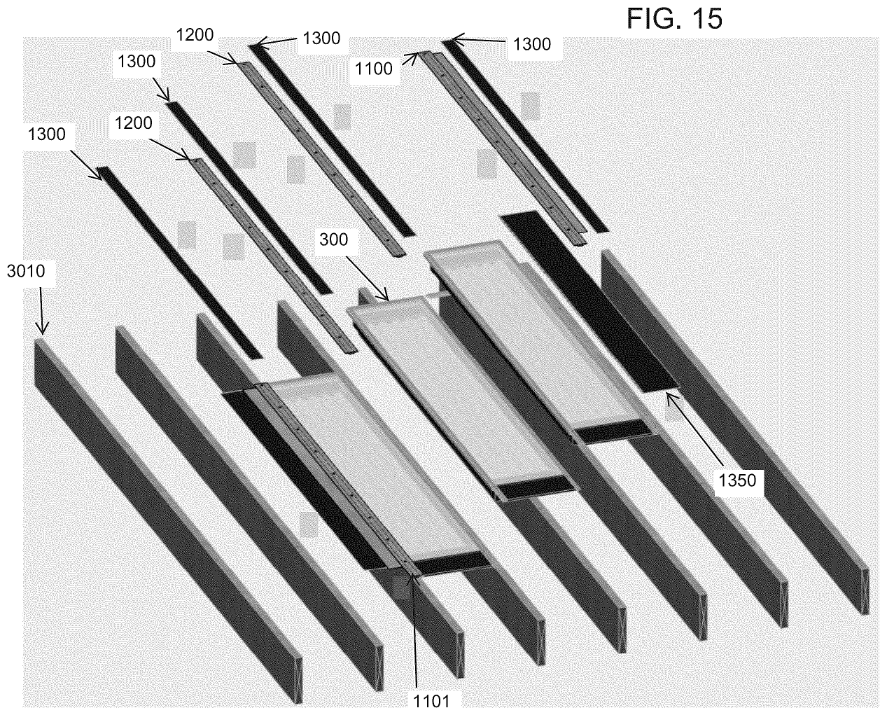

Referring to FIG. 15, bay assemblies 300 are shown placed between rafters 3010. Hold down bars, such as hold down bar 1101, are centered over a rafter 3010, so that holes 1150 line up with a center of the rafter, and the hold down bar has overhang 1130 placed above either a frame 203 or 204. In the example shown in FIG. 15, three bay assemblies 300 are shown being placed between adjacent rafters 3010, with a left side hold bar 1101 being placed over a frame 203 on the left most bay assembly, a center hold bar 1200 being placed between each side of the center bay assembly 300, so that they line up with the rafters, and a right hand side hold down bar 1100 being placed on the right side of the right most bay assembly 300. Flashing 1350 is connected to the groove 1140 on each hold down bar 1101 and 1100.

Referring to FIG. 16, a partial side cross sectional view of two adjacent bay assemblies such as assemblies 300, and a side cross sectional view of a center hold down bar 1200 is shown. In some embodiments for new construction, a spacer 1306 is used to fill the gap where plywood 3040 would instead be present in a roof cutout made for existing roofs. In other embodiments, the hold bars 1200, 1100 and 1101 can be a greater height to make up for the lack of plywood on the rafters 3010 for new construction. Bolt 1400 is shown connecting center hold down bar 1200 to rafter 3010 through hole 1150. Each hold down bar 1200, 1100, and 1101 can have more than one hole 1150, with each hole 1150 having a bolt 1400 to connect the hold down bar to a rafter or wall stud. In the examples shown in FIGS. 13 and 15, each hold down bar, 1200, 1100 and 1101 have nine holes 1150 each. In these embodiments, nine bolts can secure each hold down bar to a rafter or wall stud through the holes 1150.

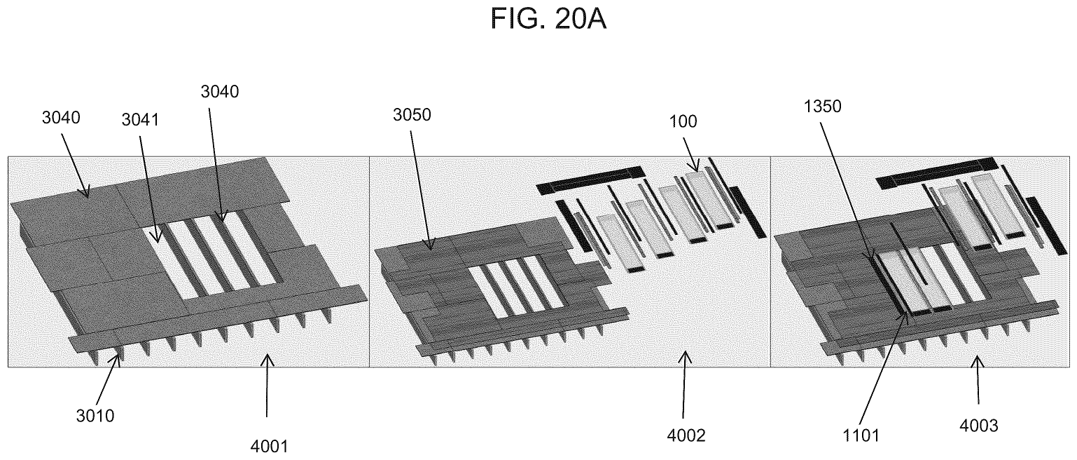

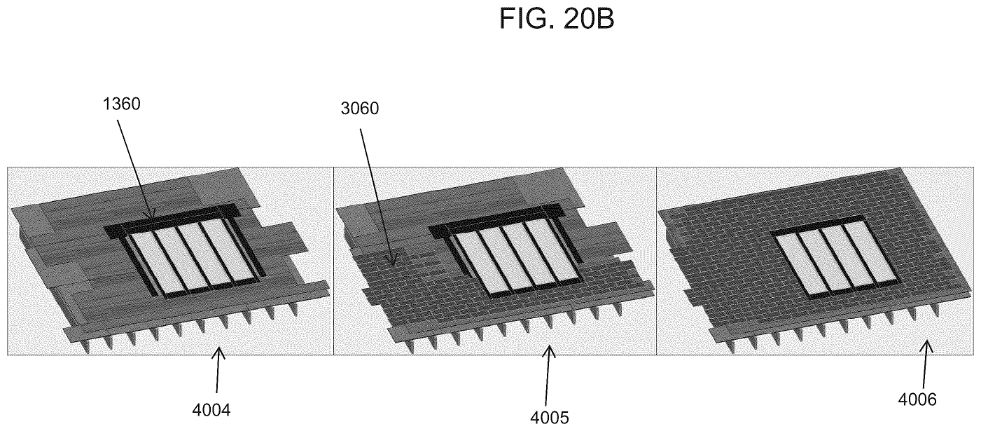

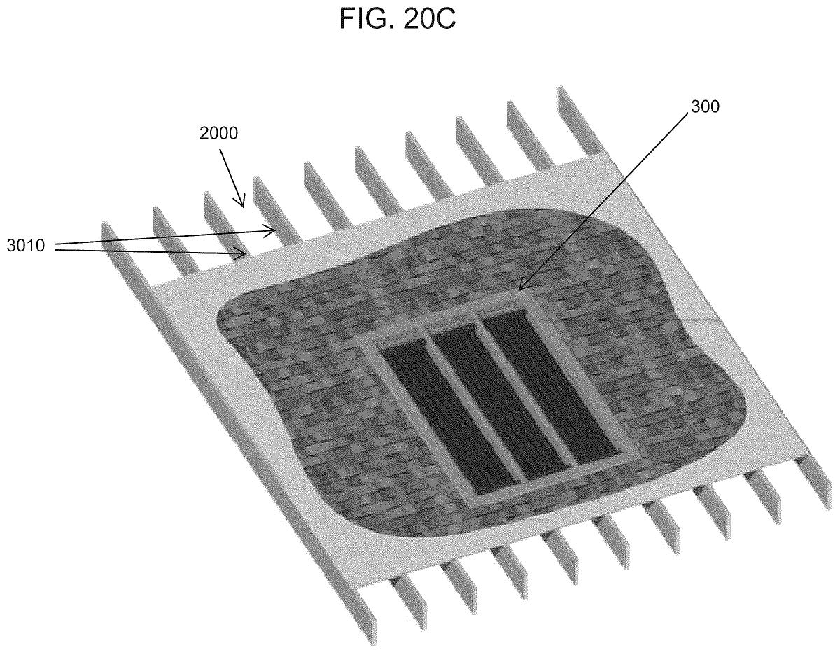

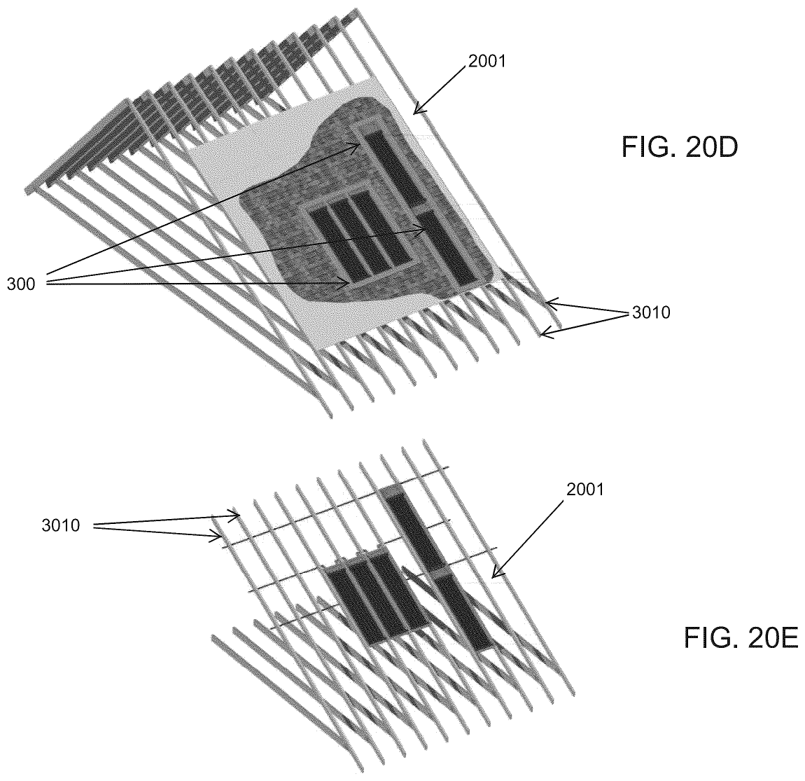

Referring to FIG. 17A, three bay assemblies 300 housing solar heaters 400 are shown connected or attached to rafters 3010 with hold down bars 1100, 1101 and 1200 that are covered with snap covers 1300 as shown. Panel 202 that is part of glass frame 200 overhangs tray 100 a shown. FIG. 17A is shown without sheathing 3040 and without barrier 3050 and shingles 3060 for illustration purposes only. Plates 1120 and flashing 1350 would normally be covered with shingles as shown in FIGS. 20A-20C. When the bay assembly is installed in a wall and attached to wall studs instead of rafters, the areas that would be covered in shingles, can be covered by wall siding 3130 instead.

Referring to FIG. 17B, three bay assemblies are shown with a top flashing 1360, that has a first portion 1361 that covers a top portion of frame 201 that is part of glass frame 200 and a second portion that is covered by shingles when the bay assemblies are installed. The first portion 1361 and second portion 1362 are separated by a right angle bend as shown in FIG. 17C. In some embodiments, flashing 1350, 1360, and portions 1361 and 1362 can be made of a variety of materials, such as metals, and can include but is not limited to aluminum, steel, copper, brass and tin.

Referring to FIG. 17C, top flashing 1360 is shown with portion 1361 covering frame 201 and portion of glass 205 and shown with portion 1362 being covered with shingles when the bay assembly is installed in a roof. When the bay assembly is similarly installed in a wall and connected to wall studs, the shingles can be replaced by wall siding 3130 instead. The top flashing 1360 aids in the weather proofing of the bay assembly installation in a wall or roof, by preventing water, moisture, ice or snow from entering the building at the site of the installation.

Referring to FIG. 17D, a side cross sectional view of panel 202, and a partial side cross sectional view of glass panel 205 and tray 100 is shown. Panel 202 is located at a bottom of a bay assembly opposite top flashing 1360 as shown in FIG. 17B. When a bay assembly is installed in a roof, panel 202 rests on top of and overlaps shingles 3060 as shown to aid in the weather proofing of the bay installation.

Referring to FIG. 17E, a partial side cross section view is shown of multiple bay assemblies 100 installed in an existing roof. A cutout 3041 is made in the plywood sheathing as shown in FIG. 20A, with the plywood 3040 being kept above rafters 3010 as shown in FIGS. 20A and 17E. In some embodiments, screw and/or bolt 1400 can be inserted through the holes in hold down bars 1200, 1100 and 1101, through the plywood 3040 and into the rafters 3010. In some embodiments, 1400 is a #12×3 stainless steel screw and can have a diameter of ⅜ inches, and a length of three inches.

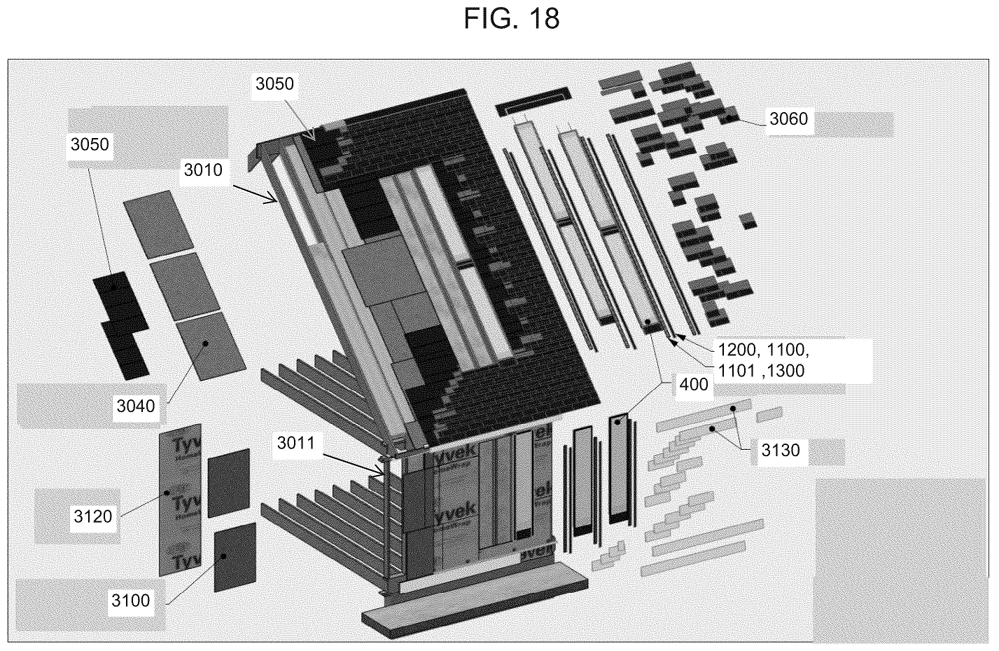

Referring to FIG. 18, a typical house section is shown in an exploded view, showing typical building components as described above in FIG. 1, with a bay assembly 300 containing solar heater 400 installed in a roof, and in a wall, as shown. For a roof installation, for an existing building, the shingles 3060, barrier 3050, and sheathing 3040 would be removed from the roof in the area that the bay assemblies will be installed. If there is a venting system, such as vent 3030, this will also be removed in the area that the bay assembly will be installed. Insulation 3020 can be kept below the bay assembly after installation is complete. The shingles 3060 can be replaced and reused to cover the flashing 1350 and 1360 and the plate 1120 as described above. The shingles 3060 can also be placed underneath panel 202 as described above. For a wall installation, for an existing building, the siding 3130, barrier 3120, and sheathing 3100 will need to be removed from the wall in the area that the bay assemblies will be installed. Insulation 3021 can be kept between the adjacent wall studs. The siding 3130 can be replaced and reused to cover the flashing 1350 and 1360 and the plate 1120. The siding 3130 can also be placed underneath panel 202 as described above.

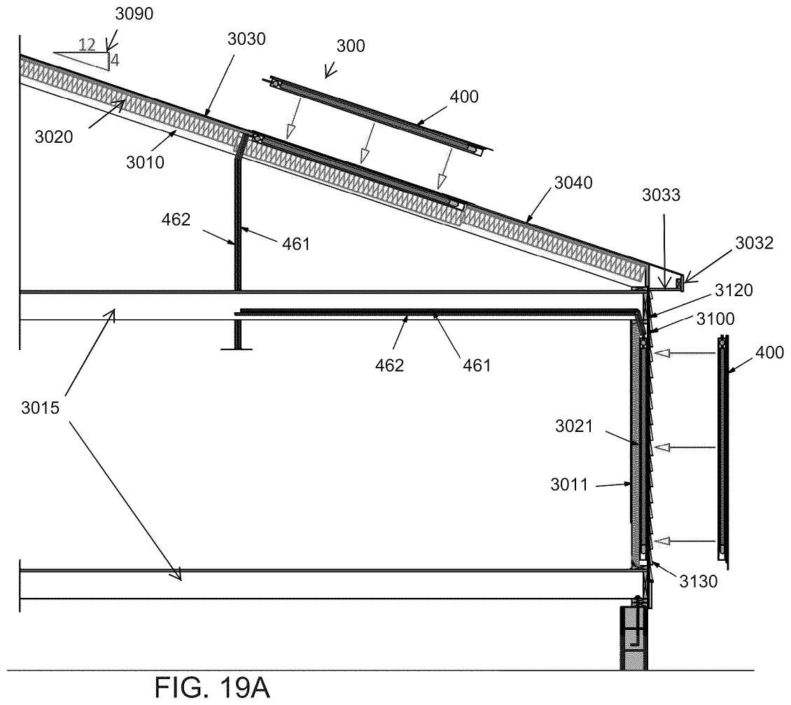

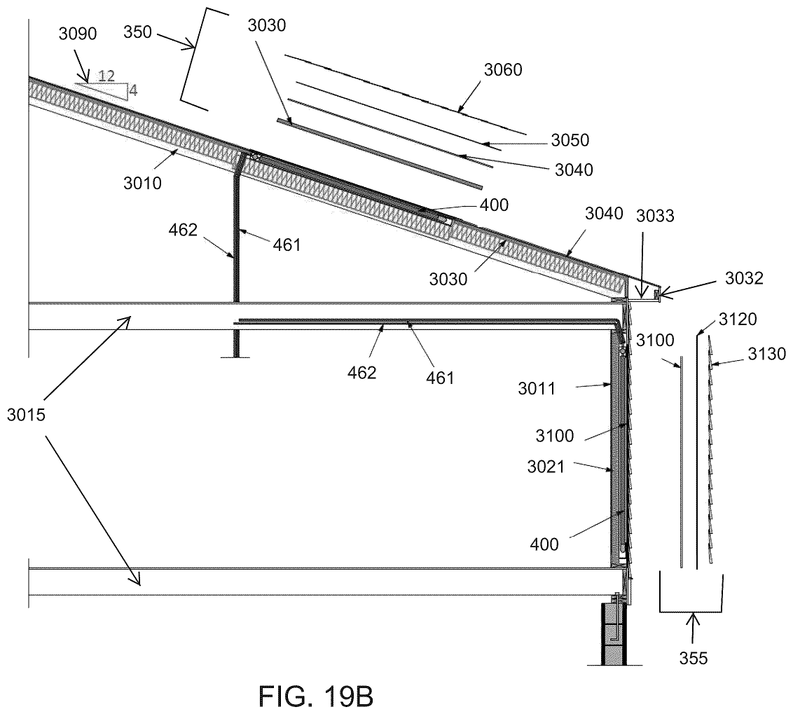

Referring to FIG. 19A, a side cross sectional view of a typical house section is shown with bay assemblies 300 being installed with solar heater 400 housed within the bays. Pitch 3090 shows that for some embodiments, the bay assembly must be installed on a roof with a minimum pitch being not less than 4 inches on 12 inches as shown. When bay 300 is installed in a roof or wall, the bay is embedded into the structure of the building, and is therefore structurally integrated into the building, rather than merely cosmetically integrated. As the internal components of the solar devices, 400, 500 and 600 are all housed in the bays, and the bays are embedded into the roof or wall as described above, none of the components are exposed to external elements and weather, which thereby increases the output efficiency of the solar heater, solar cooling plate and a combined photovoltaic with thermal backing plate devices.

Air intake or soffit vent 3033 circulates fresh outside air in the attic space. As long as at least a one inch spacing is provided between any insulation 3020 and the sheathing 3040, from the air intake 3033 to the ridge vent 3070, the bay assembly 300 can be ventilated through holes 111. Air can flow from the holes 111 in the side 102 of tray 100 through to the holes 111 in the side 101 through to the ridge vent 3070. In some cases, a corrugated vent structure, such as vent 3030, is used to maintain the at least one inch spacing.

As described above in FIGS. 7A-7D and FIG. 8, water supply line 461 and water return line 462 are connected or attached to water manifold 450 and transfer heat from tubes 410 to the water traveling though the manifold 450, that is in then piped throughout the house for heating or domestic hot water as needed. While bay assembly 300 and solar heater 400 are shown in FIGS. 19A and 19B and installed in the roof and the wall of the building, any bay assembly 800 and 1000, housing solar cooling plates 500 and a combination of photovoltaic panel with a thermal backing plate 600, respectively, can also be installed and embedded into the roof and wall as described above with respect to assembly 300.

With reference to FIG. 19B, when bay assembly 300 is installed in a roof, typical building materials 350 would need to be removed for an existing building. Materials 350 can include shingles 3060, barrier 3050, sheathing 3040 and vent structure 3030, in the area that the bay assembly 300 would need to be installed. Similarly, when bay assembly 300 is installed in a wall, typical building materials 355 would need to be removed for an existing building. Materials 355 can include siding 3130, barrier 3120, and sheathing 3100 in the area that the bay assembly 300 would need to be installed.

Referring to FIGS. 20A and 20B, installation steps 4001-4006 for the installation of the bay assemblies 100 into an existing roof are shown. At step 4001, for an existing roof, all materials such as the weatherproofing 3050, and shingles 3060 near the installation area of the assemblies are removed except for the plywood sheathing 3040. A cutout 3041 is made for each assembly 100. Plywood 3040 is kept in areas directly above rafters 3010.

At step 4002, the weatherproofing 3050 around the installation areas 3041 can be kept or newly installed.

At step 4003, the bay assemblies 100 can be installed as described herein, with hold down bars 1200, 1100 and 1101, and flashing 1350 being installed, with the snap covers 1300.

At step 4004, the top flashing 1360 can be installed.

At step 4005, the shingles 3060 can be reinstalled around the bay assemblies 100, and can cover areas of the flashing 1350, 1360 and the hold down bars 1100 and 1101 as shown.

At step 4006, all shingles have been installed, and the bay assemblies 100 are fully integrated into the building.

Referring to FIGS. 20C-20E, bay assemblies 300 are shown installed in various roofs and attached to rafters 3010. The spacing 2000 and 2001 between the center of each rafter to the center of the next adjacent rafter is 16 inches on center framing for spacing 2000 shown in FIG. 20C and is 24 inches on center framing for spacing 2001 shown in FIGS. 20D and 20E. While bay assembly 300 is shown installed on the rafters 3010, any bay assembly that houses any solar device as described herein can be installed on the rafters as shown. The bay assemblies can be sized and shaped to fit the spacings 2000 and 2001 between the rafters 3010, or other commonly used framing spacings used in the building construction. Similarly, the size of the bay assemblies can be adjusted to fit common framing spacing used in construction for framing wall studs 3011.

Bay assemblies can also be installed side by side as shown in FIG. 20C, or vertically and also side by side as shown in FIGS. 20D and 20E. Configurations of bay assemblies having different solar devices 400, 500 and 600 can also be installed together, side by side and vertically as shown. The bay assemblies 100 can also be connected together by being daisy chained as needed.

The embodiments of the bay assembly as described herein, can be installed on roofs without perfect slopes, and on roofs having surface imperfections. In some embodiments, the bay assembly is designed to accommodate at least a ¼ inch of flex over its length and width, allowing it to be installed into the roof and sidewall where rafters and/or studs have crowned in opposite directions. This flexibility allows installation of the bay assembly to accommodate roof/sidewall surfaces imperfections.

The bay assembly as described herein, is engineered to satisfy the requirements associated with Risk Category 1 through 3 (IBC 2021 Codes). Through design and proper installation, in some embodiments the bay assembly is rated to 140 mph of wind shear and wind uplift (per IRC and IBC codes). In some embodiments, the bay assembly can be modified to withstand structural requirements including wind shear and wind uplift associated with Building Risk Category 4 (IBC 2021 Codes).

While the present disclosure has been described with reference to one or more exemplary embodiments, it will be understood by those skilled in the art that various changes can be made, and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure is not limited to all the particular embodiment(s) disclosed as the best mode contemplated, but that the disclosure will also include all embodiments falling within the scope of the appended claims.

What is claimed is:

1. A bay assembly configured to house solar devices comprising:
a tray having a lip extending along a perimeter of the tray;
a glass frame having a first slot that holds a glass panel, and a second slot that accommodates the lip;
wherein the glass frame is slidably connected to the tray.

2. The bay assembly of claim 1, wherein the glass frame has an outer groove along a perimeter of the glass frame.

3. The bay assembly of claim 1, wherein the tray has a rectangular shape.

4. The bay assembly of claim 1, wherein the tray houses a solar heating device.

5. The bay assembly of claim 1, wherein the tray houses a solar cooling device.

6. The bay assembly of claim 1, wherein the tray houses a photovoltaic device combined with a thermal backing plate device.

7. The bay assembly of claim 4, wherein the solar heating device further comprises at least one evacuated tube having a metal rod extending through a center of the at least one evacuated tube.

8. The bay assembly of claim 7, wherein the solar heating device further comprises a water manifold connected to the rod via a hollow cylindrical tube portion, and wherein the water manifold has a water supply line and a water return line connected to a main chamber of the water manifold.

9. The bay assembly of claim 8, wherein the water manifold has a main chamber that is housed in the tray, and wherein the main chamber is covered in a solar blanket.

10. A method of installing the bay assembly of claim 2, into a building, comprising the steps of:
placing a first hold down bar and a second hold down bar in contact with the glass frame, so that a protrusion on the first hold down bar and a protrusion on the second hold down bar contacts the outer groove on the perimeter of the glass frame and the first hold down bar is opposite the second hold down bar;
placing a center of the first hold down bar at a center of a first rafter, and securing the first hold down bar to the first rafter by placing a bolt through a hole in the first hold down bar and into the first rafter; and
placing a center of the second hold down bar at a center of a second rafter and securing the second hold down bar to the second rafter by placing a bolt through a hole in the second hold down bar and into the second rafter so that the bay assembly is held between the first and second rafters in a roof.

11. A method of installing the bay assembly of claim 2, into a building, comprising the steps of:
placing a first hold down bar and a second hold down bar in contact with the glass frame, so that a protrusion on the first hold down bar and a protrusion on the second hold down bar contacts the outer groove on the perimeter of the glass frame and the first hold down bar is opposite the second hold down bar;
placing a center of the first hold down bar at a center of a first wall stud, and securing the first hold down bar to the first wall stud by placing a bolt through a hole in the first hold down bar and into the first wall stud; and
placing a center of the second hold down bar at a center of a second wall stud and securing the second hold down bar to the second wall stud by placing a bolt through a hole in the second hold down bar and into the second wall stud so that the bay assembly is held between the first and second wall studs in a wall.

12. A bay assembly housing a solar heating device comprising:
a tray having a lip extending along a perimeter of the tray;
a glass frame having a first slot that holds a glass panel, and a second slot that accommodates the lip;
wherein the glass frame is slidably connected to the tray;
wherein the glass frame has an outer groove along a perimeter of the glass frame;
wherein the solar heating device comprises at least one evacuated tube having a metal rod extending through a center of the at least one evacuated tube;
wherein the solar heating device comprises a water manifold connected to the metal rod via a hollow cylindrical tube portion, and wherein the water manifold has a water supply line and a water return line connected to a main chamber of the water manifold; and
wherein the main chamber of the water manifold is housed in the tray, and wherein the main chamber is covered in a solar blanket.

13. The bay assembly of claim 12, wherein the tray has a rectangular shape.

14. The bay assembly of claim 12, wherein the tray is made of plastic.

15. The bay assembly of claim 12, wherein the tray is made of metal.

16. The bay assembly of claim 12, wherein the tray is made of aluminum.

17. The bay assembly of claim 12, wherein the tray has a groove for each evacuated tube.

18. The bay assembly of claim 12, wherein the glass frame is made of aluminum.
